(19) United States
(12) Patent Application Publication
(10) Pub. No.: US 2026/0101215 A1
(43) Pub. Date: Apr. 9, 2026

(54) PRIORITIZATION OF TRANSMISSIONS IN WIRELESS COMMUNICATIONS SYSTEMS

(71) Applicant: Sharp Kabushiki Kaisha, Osaka (JP)

(72) Inventors: Sangkyu BAEK, Vancouver, WA (US); Zhanping YIN, Vancouver, WA (US); Tomoki YOSHIMURA, Camas, WA (US)

(21) Appl. No.: 18/905,478

(22) Filed: Oct. 3, 2024

(51) Int. Cl. H04W 24/10; H04W 28/02

(52) U.S. Cl. CPC H04W 24/10; H04W 28/0278

(57) ABSTRACT

A transmitter node of a telecommunications system comprises transmitter node processor circuitry and transmitter node interface circuitry. The processor circuitry of the transmitter node is configured to generate a buffer status report upon occurrence of a logical channel priority change. The interface circuitry of the transmitter node is configured to transmit the buffer status report across a radio interface to another node of the system. Methods of operating such transmitter nodes are also provided.

### TECHNICAL FIELD

The technology relates to wireless communications, and particularly to prioritization of resource transmission in wireless communication networks.

### BACKGROUND

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and NG-UTRAN, the New Radio (NR).

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth-generation system, e.g., the 5G System, also called “NR” or “New Radio”, as well as “NG” or “Next Generation”, is shown in FIG. 1, and is also described in 3GPP TS 38.300. The 5G NR network is comprised of NG RAN (Next Generation Radio Access Network) and 5GC (5G Core Network). As shown, NGRAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations (i.e. gNB & ng-eNB). A gNB node provides NR user plane and control plane protocol terminations towards the UE and is connected via the NG interface to the 5GC. The 5G NR (New Radio) gNB is connected to AMF (Access and Mobility Management Function) and UPF (User Plane Function) in 5GC (5G Core Network).

For eXtended Reality, XR, applications, 3GPP is discussing enhancements to prioritize urgent data. In general, “urgent” data means data for which a remaining lifetime of the data is smaller than a threshold value. For instance, a PDCP discard timer expiry may determine that the data is outdated. Packet Data Convergence Protocol (PDCP) is specified by 3GPP in TS 25.323 for UMTS, TS 36.323 for LTE and TS 38.323 for 5G. PDCP is located in the Radio Protocol Stack in the UMTS/LTE/5G air interface on top of the RLC layer. If the remaining time until the expiry of PDCP discard timer is smaller than a particular value, the data needs to be transmitted quickly to avoid the timer expiry before the transmission. An enhancement consideration is that a logical channel, LCH, priority which has data with smaller remaining lifetime is temporarily changed to a higher priority to have more portion of uplink resource which is assigned to the user equipment, UE, e.g., wireless terminal. Changing LCH priority is used for logical channel prioritization. LCP, which determines the amount of the resource that the LCH can use. This mechanism of changing LCH priority depending on the presence of urgent data is referred to as “dynamic LCH priority”. A smaller priority value means higher priority. In Release 18 of the 3GPP NR MAC specification, priority 1 means the highest priority and priority 16 means the lowest priority. In an exemplary embodiment, urgent data may mean delay-critical data defined in 3GPP specifications [TS 38.323, TS 38.322, TS 38.321].

FIG. 2 depicts an example scenario involving dynamic LCH priority. In the example of FIG. 2, a first logical channel, e.g., logical channel 1, LCH1, has two LCH priority values. The first priority value is 10 which is used when there is no available data with remaining time less than a threshold for this LCH. The second priority is 3 which is used when there is available data with remaining time less than a threshold for this LCH. When a packet arrives in the UE, the packet is not considered as urgent data. The example of FIG. 2 assumes the packet has not been transmitted until the remaining time is smaller than a remaining time threshold. Once there is a packet with remaining timer smaller than the threshold, the logical channel priority is changed to the second priority, e.g., priority 3, high priority, which is used in LCP. Meanwhile, the packet is included in a MAC PDU, Medium Access Control Protocol Data Unit, multiplexing data from at least one of LCHs, e.g., data from LCH1 with priority 3 and data from other logical channel with priority 11 are multiplexed in FIG. 2). After the urgent data has been transmitted, the priority goes back to the first priority, i.e., priority 10.

The use of dynamic LCH priority currently involves several issues:
1) When a MAC PDU is transmitted on Physical Downlink Shared Channel, PUSCH, the priority of uplink grant is determined to prioritize one uplink resource when there are at least two uplink resources overlapping with each other in time domain. 3GPP TS 38.321 defines how to determine the priority of an uplink grant in case that LCH priority does not change. In a case that the MAC PDU to transmit is already stored in the HARQ buffer, e.g., for retransmission, the priority of an uplink grant is determined by the highest priority among priorities of the logical channels that are multiplexed in the MAC PDU. In a case that the MAC PDU to transmitted is not stored in the HARQ buffer, the priority of an uplink grant is determined by the highest priority among priorities of the logical channels that can be multiplexed in the MAC PDU, according to the mapping restrictions as described in 3GPP TS 38.321. The priority of an uplink grant for which no data for logical channels is multiplexed or can be multiplexed in the MAC PDU is lower than either the priority of an uplink grant for which data for any logical channels is multiplexed or can be multiplexed in the MAC PDU or the priority of the logical channel triggering an SR. But in a case of dynamic LCH priority, there is a mismatch between LCH priority at the transmission and LCH priority at multiplexing of a MAC PDU. What is needed, among other things, is a priority rule of uplink grant in the case of dynamic LCH priority.
2) When dynamic LCH priority is used, the receiver, e.g., a network node such as base station in uplink transmission, does not know which priority is being used or the receiver may not know the presence of data from highest priority logical channel. What is needed, among other things, is signaling of presence of highest priority data based on a buffer status report.
3)When data arrives in the wireless terminal, UE, and there is no available uplink resource, a scheduling request, SR, is triggered and transmitted on Physical Uplink Control Channel, PUCCH, logical channel. When dynamic LCH priority is used and an SR is transmitted on PUCCH, the priority of the SR is determined based on the priority of the logical channel which triggered the SR. The priority of SR transmission is used to decide whether the SR transmission is prioritized over other overlapping uplink resources in the time domain. A third example aspect of the technology disclosed herein concerns, e.g., which LCH priority is used for a priority rule of an SR transmission which determines the priority of SR transmission, e.g., priority of a logical channel which triggered an SR transmission, to be used for prioritization among overlapping resources.

What is needed are methods, apparatus, and/or techniques to address one or more of the above-described problems.

### SUMMARY

In one of its example aspects the technology disclosed herein concerns a node which serves as a transmitter node of a telecommunications system. In an example embodiment and mode the transmitter node comprises transmitter node processor circuitry and transmitter node interface circuitry. The processor circuitry of the transmitter node is configured to make a determination of priority of a transmission grant dependent on a logical channel priority for a medium access control (MAC) protocol data unit (PDU) associated with the grant. The interface circuitry of the transmitter node is configured to transmit the protocol data unit across a radio interface to a receiver node of the system in accordance with the priority of the grant. Methods of operating such transmitter nodes are also provided.

In another of its example aspects the technology disclosed herein concerns a node which serves as a receiver node of a telecommunications system. In an example embodiment and mode the receiver node comprises receiver node processor circuitry and receiver node interface circuitry. The processor circuitry of the receiver node is configured to generate one or more message(s) comprising (1) plural possible logical channel priorities for a transmission grant to a transmitter node of the system which makes a selection between the plural possible logical channel priorities to be used by the transmitter node in determining a priority of the transmission grant; and (2) a threshold value to be used by the transmitter node in determining a priority of the transmission grant. The interface circuitry of the receiver node is configured to transmit the one or more messages across a radio interface to the transmitter node and to receive at least one protocol data unit associated with the transmission grant. Methods of operating such receiver nodes are also provided.

In one of its example aspects the technology disclosed herein concerns a node which serves as a transmitter node of a telecommunications system. In an example embodiment and mode the transmitter node comprises transmitter node processor circuitry and transmitter node interface circuitry. The processor circuitry of the transmitter node is configured to generate a buffer status report upon occurrence of a logical channel priority change. The interface circuitry of the transmitter node is configured to transmit the buffer status report across a radio interface to another node of the system. Methods of operating such transmitter nodes are also provided.

In another of its example aspects the technology disclosed herein concerns a node which serves as a receiver node of a telecommunications system. In an example embodiment and mode the receiver node comprises receiver node processor circuitry and receiver node interface circuitry. The interface circuitry of the receiver node is configured to receive a buffer status report from another node. The processor circuitry of the receiver node is configured to determine from the buffer status report whether the buffer status report was generated upon occurrence of a logical channel priority change. Methods of operating such receiver nodes are also provided.

In one of its example aspects the technology disclosed herein concerns a node which serves as a transmitter node of a telecommunications system. In an example embodiment and mode the transmitter node comprises transmitter node processor circuitry and transmitter node interface circuitry. The transmitter node processor circuitry is configured to make a determination of priority of a scheduling request triggered by a logical channel. The transmitter node interface circuitry is configured to transmit the scheduling request across a radio interface to another node of the system in accordance with the priority for the scheduling request. Methods of operating such transmitter nodes are also provided.

In one of its example aspects the technology disclosed herein concerns a node which serves as a transmitter node of a telecommunications system. In an example embodiment and mode the transmitter node comprises transmitter node processor circuitry and transmitter node interface circuitry. The transmitter node processor circuitry configured to select between plural scheduling request configurations depending on a LCH priority which triggers the scheduling request. The transmitter node interface circuitry is configured to transmit the scheduling request across a radio interface to another node of the system in accordance with a priority associated with the scheduling request configuration.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a diagrammatic view of an example scenario of dynamic LCH priority.

FIG. 3 is a diagrammatic view of an example scenario of dynamic LCH priority in which a same priority that is used during logical channel prioritization is used for LCH priority to determine the priority of uplink grant.

FIG. 4 is a diagrammatic view showing example acts or steps comprising an example implementation of the scenario of FIG. 3.

FIG. 5 is a schematic view showing an example communications system configured to implement the scenario of FIG. 3.

FIG. 6 is a diagrammatic view of an example scenario of dynamic LCH priority in which for retransmission, a same UL grant priority is kept.

FIG. 7 is a diagrammatic view showing example acts or steps comprising an example implementation of the scenario of FIG. 6.

FIG. 8 is a schematic view showing an example communications system configured to implement the scenario of FIG. 6.

FIG. 9 is a diagrammatic view of an example scenario of dynamic LCH priority in which for retransmission, a current LCH priority can be used.

FIG. 10 is a diagrammatic view showing example acts or steps comprising an example implementation of the scenario of FIG. 9.

FIG. 11 is a schematic view showing an example communications system configured to implement the scenario of FIG. 9.

FIG. 12 is a diagrammatic view of an example scenario of dynamic LCH priority in which a first priority or legacy LCH priority is always used.

FIG. 13 is a diagrammatic view showing example acts or steps comprising an example implementation of the scenario of FIG. 12.

FIG. 14 is a schematic view showing an example communications system configured to implement the scenario of FIG. 12.

FIG. 15 is a diagrammatic view of an example scenario of dynamic LCH priority in which a, if a LCH data multiplexed in the MAC PDU includes the data with remaining time less than the threshold, a second priority, e.g., enhanced priority, is used.

FIG. 16 is a diagrammatic view showing example acts or steps comprising an example implementation of the scenario of FIG. 15.

FIG. 17 is a schematic view showing an example communications system configured to implement the scenario of FIG. 15.

FIG. 18 is a diagrammatic view of an example scenario in which a buffer status report is generated upon occurrence of a logical channel priority change

FIG. 19 is a diagrammatic view showing example acts or steps comprising an example implementation of the scenario of FIG. 18.

FIG. 20 is a schematic view showing an example communications system configured to implement the scenario of FIG. 18.

FIG. 21 is a diagrammatic view of an example scenario in which a buffer status report is generated upon occurrence of a logical channel priority change when a priority of a logical channel becomes higher than any other logical channel having available data.

FIG. 22 is a diagrammatic view showing example acts or steps comprising an example implementation of the scenario of FIG. 21.

FIG. 23 is a schematic view showing an example communications system configured to implement the scenario of FIG. 21.

FIG. 24 is a diagrammatic view of an example scenario in which a buffer status report is generated when a LCH priority is changed to a higher priority.

FIG. 25 is a diagrammatic view showing example acts or steps comprising an example implementation of the scenario of FIG. 24.

FIG. 26 is a schematic view showing an example communications system configured to implement the scenario of FIG. 24.

FIG. 27 depicts an example first embodiment of a short buffer status report, BSR, format which can be used in case of a BSR triggered due to a LCH priority change.

FIG. 28 depicts an example second embodiment of a short buffer status report, BSR, format which can be used in case of a BSR triggered due to a LCH priority change.

FIG. 29 depicts an example embodiment of a long buffer status report, BSR, format which can be used in case of a BSR triggered due to a LCH priority change.

FIG. 30 is a diagrammatic view of an example scenario of determining scheduling request priority according to a first example embodiment and mode.

FIG. 31 is a diagrammatic view showing example acts or steps comprising an example implementation of the scenario of FIG. 30.

FIG. 32 is a schematic view showing an example communications system configured to implement the scenario of FIG. 30.

FIG. 33 is a diagrammatic view of an example scenario of determining scheduling request priority according to a second example embodiment and mode.

FIG. 34 is a diagrammatic view showing example acts or steps comprising an example implementation of the scenario of FIG. 33.

FIG. 35 is a schematic view showing an example communications system configured to implement the scenario of FIG. 33.

FIG. 36 is a diagrammatic view of an association of one of plural scheduling request configurations with a logical channel.

FIG. 37 is a schematic view showing an example communications system configured to implement the scenario of FIG. 36.

FIG. 38 is a diagrammatic view showing example elements comprising electronic machinery which may comprise a wireless terminal, a radio access node, and a core network node according to an example embodiment and mode.

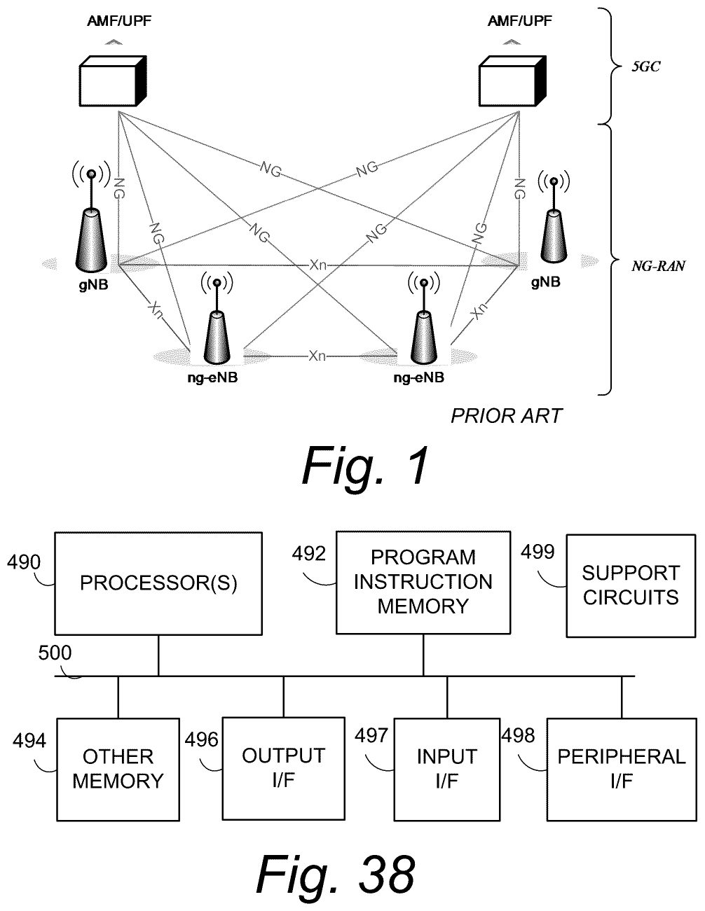

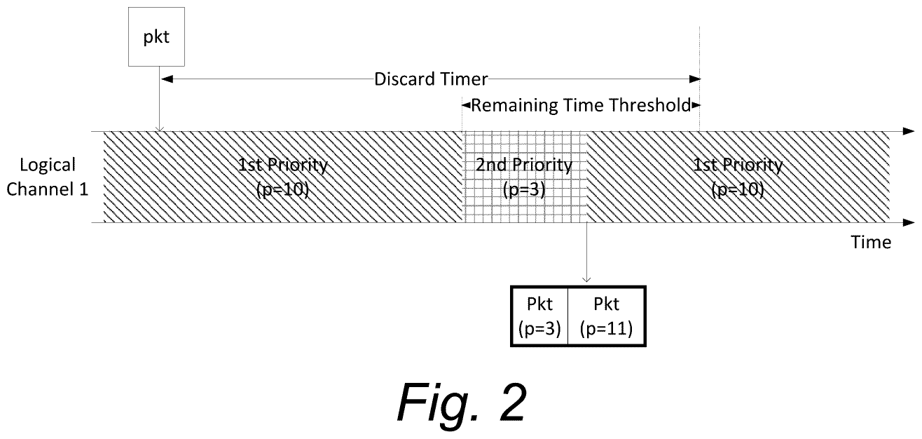

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”); IMT-2020, e.g., 5G; IMT-2030, e.g., 6G, etc. All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

A core network (CN) may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. A core network may communicate over a RAN-CN interface (e.g., N2 interface) with one or more radio access networks (RAN).

A radio access network (RAN) may communicate with one or more core networks. A radio access network (RAN) typically comprises plural access nodes. As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

A radio access network (RAN) 22 serves wireless terminals, which also form part of the radio access network (RAN). As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

A wireless terminal communicates with its serving radio access network (RAN) over a radio or air interface. Communication between radio access network (RAN) and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

Communication between radio access network (RAN) 24 and wireless terminal over the radio interface may occur on various layers. Layer 1 includes radio layer 1 or the physical layer. Higher layers, e.g., layers higher than Layer 1 may include radio layer 2 and radio resource control layer 3. The layer 1 communication may occur by utilization of “resources”. Reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two-dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe. That is, one symbol on one sub-carrier in the sub-frame comprises a resource element (RE) which is uniquely defined by an index pair (k,l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix

In 5G New Radio (“NR”), a frame consists of 10 ms duration. A frame consists of 10 subframes with each having 1 ms duration similar to LTE. Each subframe consists of 2^{μ} slots. Each slot can have either 14 (normal CP) or 12 (extended CP) OFDM symbols. A Slot is a typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slots help to achieve lower latency in 5G NR architecture. Unlike slots, mini-slots are not tied to the frame structure. It helps in puncturing the existing frame without waiting to be scheduled. See, for example, https://www.rfwireless-world.com/5G/5G-NR-Mini-Slot.html, which is incorporated herein by reference.

In general, communication protocols between the wireless terminal and the telecommunication system may be categorized into Access Stratum (AS) and Non-Access Stratum (NAS). AS protocols, such as Radio Resource Control (RRC) and Medium Access Control (MAC), may be used for the wireless terminal to communicate with access nodes of a RAN, whereas NAS protocol(s), such as the NAS protocol specified in 3GPP TS 24.501, may be used for the wireless terminal to communicate with entities (e.g., AMF) of a CN(s), via access nodes of a RAN. Consequently, the wireless terminal may comprise a function to manage the AS protocols, and a separate function to manage the NAS protocol(s). Herein, terminology “NAS” may be used in some context to refer to the function built into the wireless terminal to manage the NAS protocol(s). Similarly, “RRC” may be used in some context to refer to the function built into the wireless terminal to manage the RRC protocol.

5G includes two cell group types: Master Cell Group (MSG) and Secondary Cell Group (SCG). The Master Cell Group is a group of serving cells associated with the Master RAN Node, comprising of the SpCell (Special Cell) which is known as the PCell (Primary Cell) and optionally one or more SCell (Secondary Cell). A PCell is used to initiate the initial access and considered as main cell in MCG. The Secondary Cell Group is a group of serving cells associated with the Secondary RAN Node, comprising of the SpCell which is known as the PSCell (Primary SCell) and optionally one or more SCells. UE might be configured with one or more SCell in connected mode. SCell can be activated or deactivated according to traffic.

### 1.0 Determining Priority of Uplink Grant

A first example aspect of the technology disclosed herein determines which LCH priority is used for a priority rule of an uplink grant which determines the priority of uplink grant. In the first example aspect a node of a telecommunications system makes a determination of priority of a transmission grant dependent on a logical channel priority for a medium access control (MAC) protocol data unit (PDU) associated with the grant. In an example embodiment and mode, the node comprises processor circuitry and interface circuitry. The processor circuitry is configured to make a determination of priority of a transmission grant dependent on a logical channel priority for a medium access control (MAC) protocol data unit (PDU) associated with the grant. The interface circuitry is configured to transmit the protocol data unit across a radio interface to another node of the system in accordance with the priority of the grant.

The first example aspect of the technology disclosed herein encompasses plural sub-aspects, alternatives, or options, as discussed below.

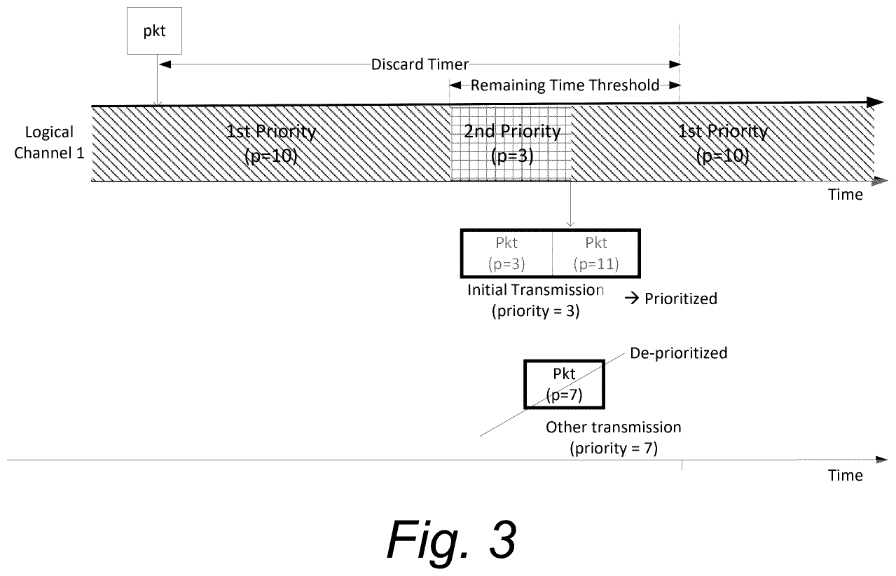

In Option 1.1, described with reference to FIG. 3-FIG. 5, a same priority is used during logical channel prioritization is used for LCH priority to determine the priority of uplink grant.

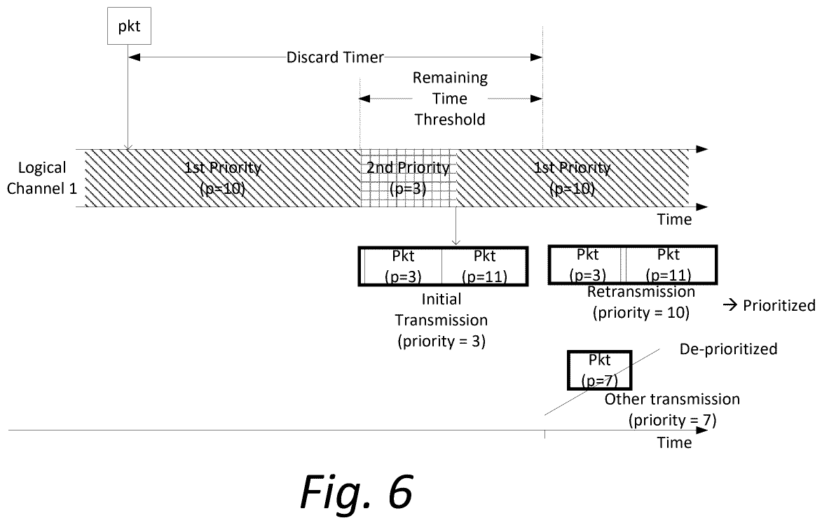

In Option 1.1.1, described with reference to FIG. 6-FIG. 8, for retransmission, the same UL grant priority is kept.

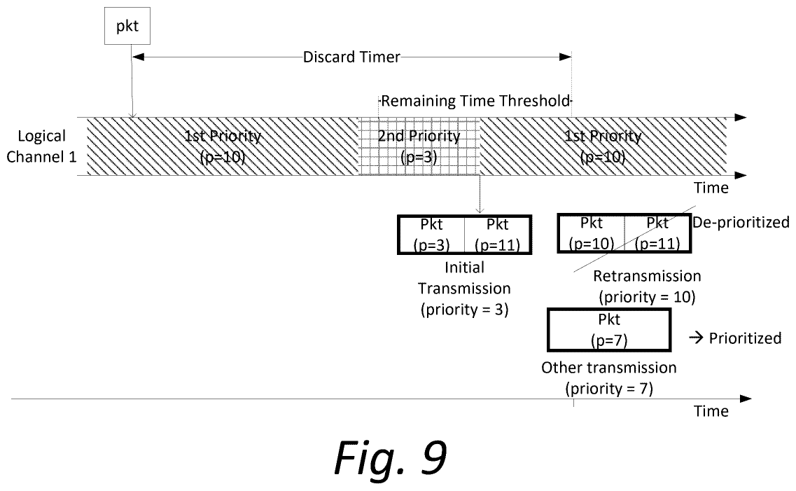

In Option 1.1.2, described with reference to FIG. 9-FIG. 11, for retransmission, a current LCH priority can be used.

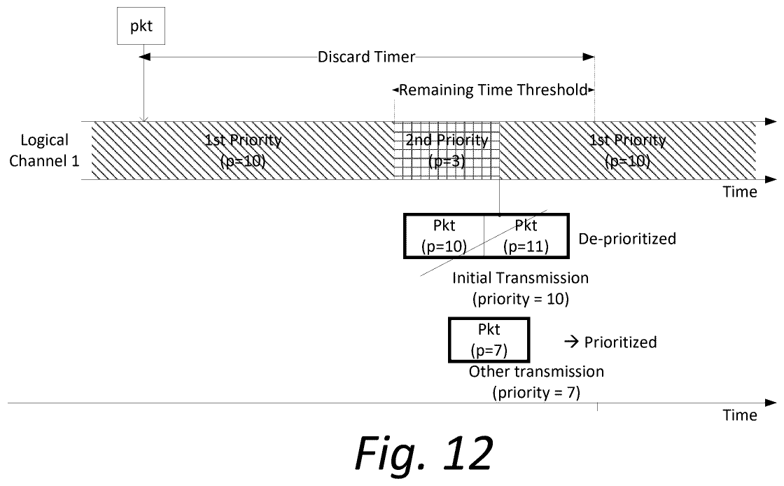

In Option 1.2, described with reference to FIG. 12-FIG. 14, a first priority, e.g., legacy LCH priority, is always used.

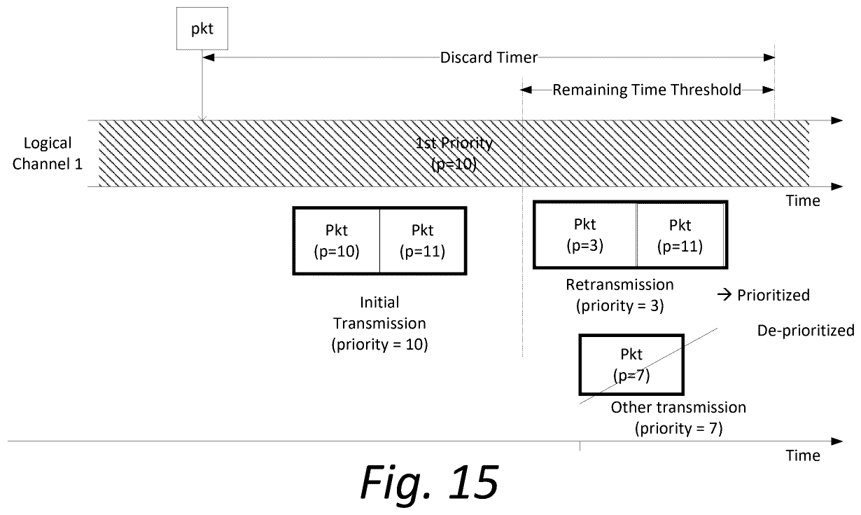

In Option 1.3, described with reference to FIG. 15-FIG. 18, if a LCH data multiplexed in the MAC PDU includes the data with remaining time less than the threshold, a second priority, e.g., enhanced priority, is used.

### 1.1 Determination Based on a Logical Channel Priority at a Time of Multiplexing of Data for the PDU

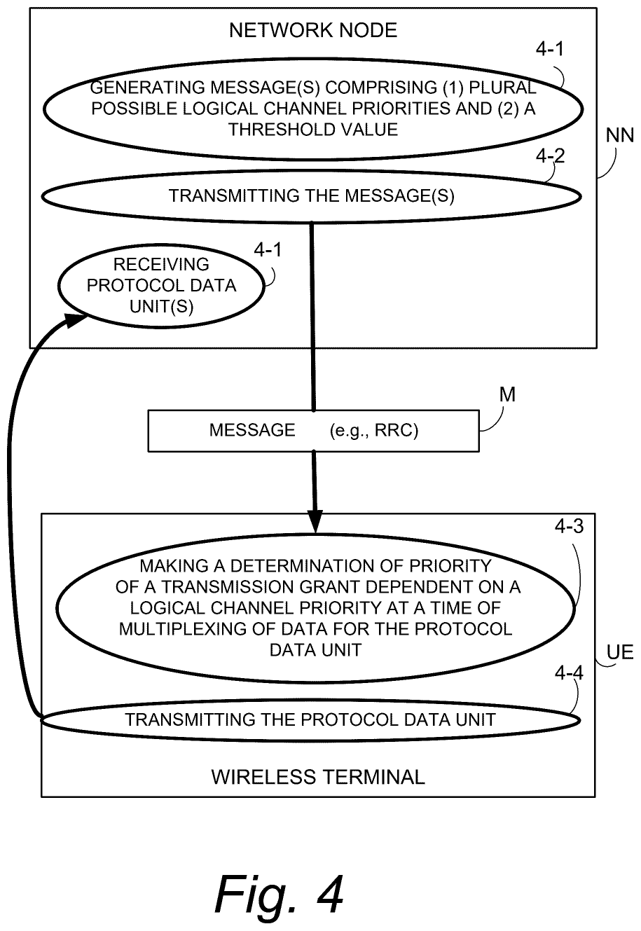

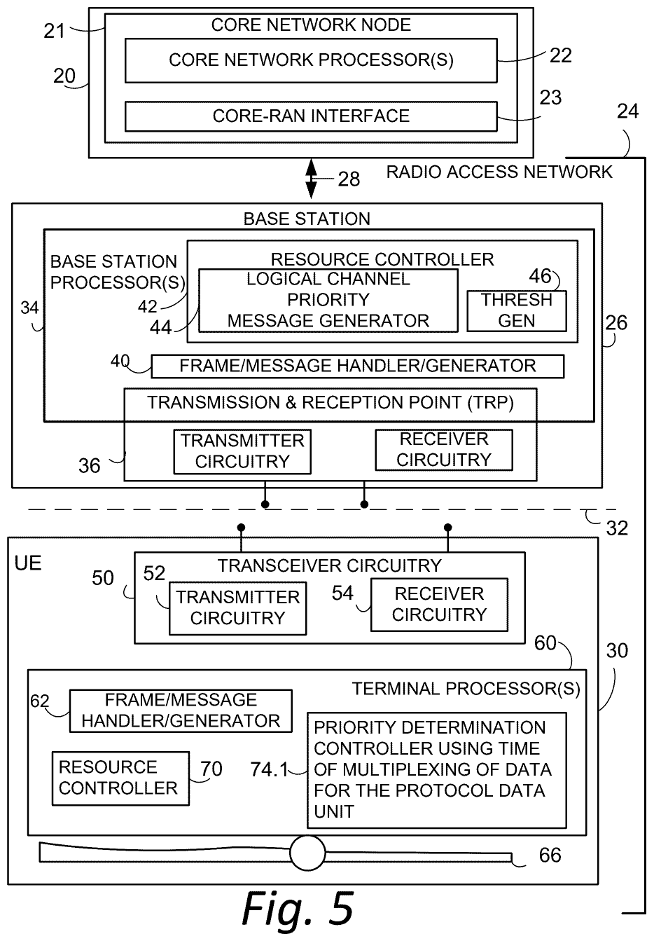

Sub-aspect 1.1 concerns how to determine priority of an uplink grant, considering dynamic LCH priority. Sub-aspect 1.1 encompasses an example scenario of dynamic LCH priority in which a same priority that is used during logical channel prioritization is used for LCH priority to determine the priority of uplink grant. For example, sub-aspect 1.1 encompasses a determination based on a logical channel priority at a time of multiplexing of data for the protocol data unit. An example scenario of sub-aspect 1.1 is illustrated in FIG. 3, example acts or steps comprising an example implementation of the scenario of FIG. 3 are shown in FIG. 4, and FIG. 5 shows an example communications system configured to implement the scenario of FIG. 3.

FIG. 3 depicts one of the proposed methods, e.g., sub-aspects, which determine the priority of an uplink grant when dynamic priority is used. In FIG. 3-FIG. 5, a node which serves as a receiver node, such as a base station, can configure two LCH priority values for each logical channel. The two priority values are configured by an RRC message transmitted by the receiver the node to another node, e.g., a transmitter node, such as a wireless terminal, e.g., UE. In the example, the first priority value of LCH1 is 10 which is used when there is no available data with remaining time less than a threshold for this LCH. The second priority is 3 which is used when there is available data with remaining time less than a threshold for this LCH. When a packet arrives in the UE, the packet is not considered as urgent data. The example assumes the packet has not been transmitted until the remaining time is smaller than a remaining time threshold. Once there is a packet with remaining timer smaller than the threshold, the logical channel priority is changed to the second priority, e.g., priority 3, high priority, which is used in LCP. Meanwhile, the packet is included in a MAC PDU, Medium Access Control Protocol Data Unit, multiplexing data from at least one of LCHs, data from LCH1 with priority 3 and data from other logical channel with priority 11 are multiplexed in FIG. 3. As the urgent data has been transmitted or included in the MAC PDU, the priority is going back to the first priority, e.g., priority 10.

However, the priority of an uplink grant is based on the LCH priority at the time of multiplexing of the data. In other words, the priority of an uplink grant is based on the LCH priority at the LCP procedure for the MAC PDU associated to the uplink grant. Thus, the priority of the uplink grant is determined based on that the priority of LCH1 is 3 for the uplink grant. Thus, the priority of the uplink grant in the example is determined as 3, which is the highest priority of LCHs which can be multiplexed in the MAC PDU at the time of LCP for the MAC PDU. In the example, there is an overlapped uplink grant in time domain, which has data from an LCH with priority 7. Thus, the priority of the overlapped uplink grant is 7. So, the uplink grant with priority 3 is prioritized, delivered to the lower layer, e.g., physical layer, and transmitted to the base station. The other overlapped grant with priority 7 is de-prioritized and not delivered to the lower layer. Hence, an uplink grant which can transmit higher priority data can be prioritized, and its higher priority is kept regardless of the change of LCH priority depending on buffered data not transmitted at the time.

Example acts or steps comprising an example implementation of the scenario of FIG. 3 are shown in FIG. 4. Act 4-1 comprises a receiver node, such as a network node, such as network node NN, for example, generating one or more message(s) comprising (1) plural possible logical channel priorities for a transmission grant to another node of the system which makes a selection between the plural possible logical channel priorities to be used by the another node in determining a priority of the transmission grant; and (2) a threshold value to be used by the another node in determining a priority of the transmission grant. Act 4-2 comprises the network node transmitting the one or more messages M across a radio interface to another node, such as a receiver node, which is illustrated in FIG. 4 as being a wireless terminal, UE. Act 4-3 comprise the transmitter node, e.g., a wireless terminal, after receiving the message M, making a determination of priority of a transmission grant dependent on a logical channel priority at a time of multiplexing of data for the protocol data unit, as understood with reference to FIG. 3. Act 4-4 comprises the transmitter node transmitting the protocol data unit across a radio interface to another node of the system in accordance with the priority of the grant of act 4-3. Act 4-5 comprises the receiver node, e.g., the network node, receiving at least one protocol data unit associated with the transmission grant, e.g., the transmission of act 4-4.

FIG. 5 shows a communications system which comprises a network node NN and a wireless terminal UE which may be utilized to implement the scenario of FIG. 3 and acts of FIG. 4. It should be understood that herein “network” may be used interchangeably with “network node”, except where otherwise clear from the context. The network node NN may be either a core network node or a node of a radio access network, such as a RAN access node, e.g., a base station node, for example. In the particular example shown in FIG. 5, network node NN of FIG. 4 comprises a radio access network. However, it should be understood that in other implementations and embodiments the network node NN may comprise a core network node. In example embodiments and modes in which the network node NN is a core network node, it should be understood that the core network node communicates through a radio access node to to other nodes, such as to the wireless terminal. The wireless terminal UE may be any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc. be any

FIG. 5 show in example structures and functionalities that may comprise or be included in the communications network of FIG. 5. FIG. 5 shows that the example communications networks, which may be 5G networks, for example, comprise core network 20. The core network 20 may comprise one or more core network nodes, such as core network node 21. The core network node 21 may comprise or be realized by any suitable type of core network node, such as a core network management entity, e.g., an Access and Mobility Management Function (AMF). One or more of the core network nodes 21 may comprise core node processor circuitry, such as core node processor(s) 22. The core network 20 and one or more of its constituent core network nodes 21 is connected to at least one radio access network 24 through a core-RAN interface circuit 23. The core-RAN interface circuit 23 may be connected to wireline(s) 28.

The radio access network 24 in turn comprises one or more radio access network (RAN) nodes, such as example base station node 26. The base station node 26 serves at least one cell. The radio access network, RAN, 24 typically comprises plural access nodes, one example access node 26 being illustrated as a base station node in FIG. 5.

FIG. 5 shows the radio access network 24, and base station node 26 through its cell in particular communicating with wireless terminal 30 across a radio or air interface 32. The base station node 26 may, and usually does, communicate with plural wireless terminals across the air interface 32. Only one wireless terminal 30 is shown for sake of simplicity, it being understood that other wireless terminals may be provided and may operate in similar manner as the wireless terminal 30 herein illustrated.

In the example embodiment and mode shown in FIG. 5, the base station node 26 serves as a receiver node and the wireless terminal 30 serves as a transmitter node. It should be understood, however, such as communications in an opposite direction, that the roles may be reversed so that the base station node 26 serves as a transmitter node and the wireless terminal 30 serves as a receiver node.

FIG. 5 shows base station node 26 as comprising base station processor circuitry which may comprise one or more base station processors 34, as well as base station transceiver circuitry 36. As illustrated in 5, the base station transceiver circuitry 36 may be a transmission and reception point (TRP). The transmission and reception point (TRP) 36 may further comprise transmitter circuitry and receiver circuitry. The base station processors 34 may comprise frame/message handler/generator 40 which prepares and generates information including user data and messages, e.g., signaling, for transmission over the radio interface 32, as which also processes information received over the radio interface 32.

The base station node 26 may be structured essentially as shown in FIG. 5 or may be a node having architecture such as split architecture comprising a central unit and one or more distributed units that comprise mobile termination (MT). The base station processor(s) may include one or more TRPs.

FIG. 5 also shows various example constituent components and functionalities of wireless terminal 30. For example, FIG. 5 shows wireless terminal 30 as comprising terminal transceiver circuitry 50. The transceiver circuitry 50 in turn may comprise terminal transmitter circuitry 52 and terminal receiver circuitry 54. The terminal transceiver circuitry 50 may include antenna(e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 5 further shows wireless terminal 30 also comprising wireless terminal processor circuitry, e.g., one or more wireless terminal processor(s) 60. The wireless terminal 30, e.g., wireless terminal processor(s) 60, may comprise terminal frame or message handler/generator 62. The wireless terminal 30 may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

In the example embodiment and mode of FIG. 5 the network node NN which performs acts such as act 6-1 and act 6-2 of FIG. 6 is a radio access node. As mentioned above, the network node of FIG. 4 also be a core network node, such as core network node 21 of FIG. 5. FIG. 5 particularly shows that the base station processor(s) 34 of base station node 26 comprise resource controller 42 which serves to configure resources for use between the network node and a wireless terminal. The resource controller 42 or other portions of base station processors 34 comprise logical channel priority message generator, logical channel priority message generator 44, and threshold value message generator 46. Using logical channel priority message generator 44 and threshold value message generator 46 the network node generates the message(s) of act 4-1 which comprising (1) plural possible logical channel priorities for a transmission grant to another node of the system which makes a selection between the plural possible logical channel priorities to be used by the another node in determining a priority of the transmission grant; and (2) a threshold value to be used by the another node in determining a priority of the transmission grant. The messages may be separate messages or a single message such as message M shown in FIG. 4.

Further, in the example embodiment and mode of FIG. 5, the base station transceiver circuitry 36, under direction of base station processor(s) 34, transmits the message M.

The wireless terminal 30 of 5 may perform the acts 4-3 through and including 4-4 of FIG. 4. In particular the wireless terminal processor(s) 60 may be involved in performing act 4-3. The wireless terminal processor(s) 60 are configured to perform many functions for operation of the wireless terminal in general, as known to the person skilled in the art. For performing functions germane to the technology disclosed herein, in an example embodiment and mode the wireless terminal processor(s) 60 may be structured or configured to comprise or realize several functionalities or units including resource controller 70 and a priority determination controller 72.1. The priority determination controller 72.1 is configured to make the determination of priority of a transmission grant dependent on a logical channel priority for a medium access control (MAC) protocol data unit (PDU) associated with the grant, and particularly for the FIG. 3 and FIG. 4 sub-aspect to make the determination based on a logical channel priority at a time of multiplexing of data for the protocol data unit as understood with reference to FIG. 3.

While FIG. 4 and FIG. 5 have shown the transmitter node to be a wireless terminal such as UE 30 and the receiver node to be a network node such as base station node 26, it should also be understood that the roles may be inverted for some communications systems, e.g., the wireless terminal may serve as the receiver node and the network node may serve as the transmitter node.

### 1.1.1 Determination for Retransmission Based on Same Based on a Logical Channel Priority at a Time of Multiplexing of Data for the PDU

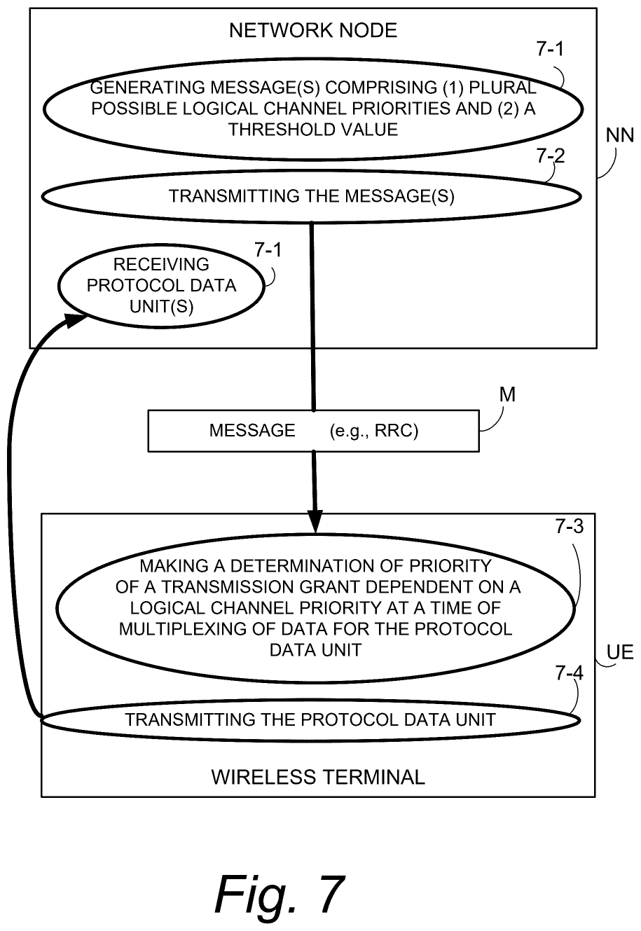

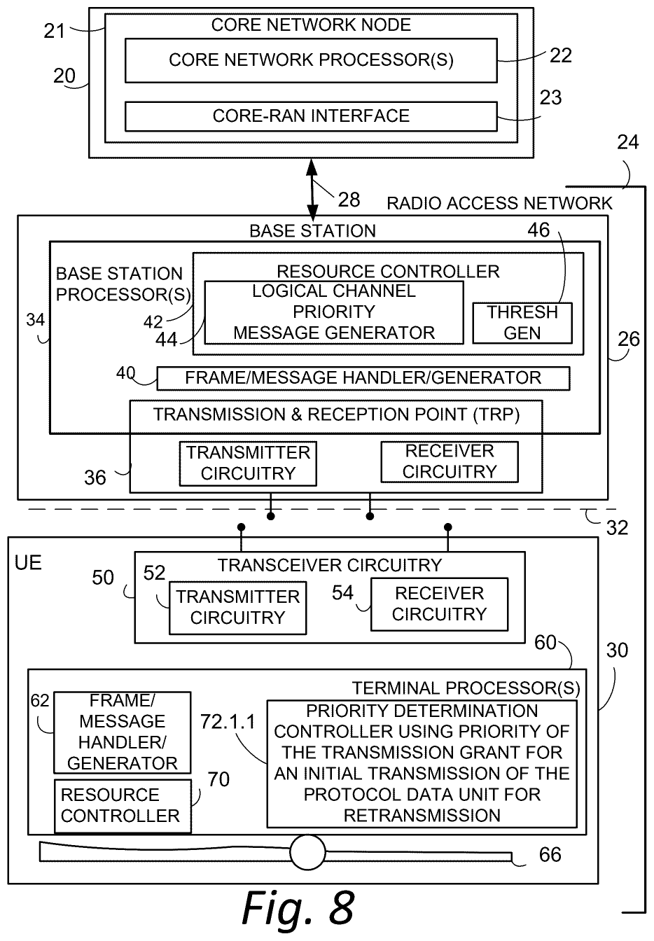

Sub-aspect 1.1.1 encompasses an example scenario of dynamic LCH priority in which, for retransmission of a protocol data unit, the same UL grant priority is kept. For example, sub-aspect 1.1.1 encompasses a determination of priority of a transmission grant for retransmission of the protocol data unit being dependent on the determination of priority of the transmission grant for an initial transmission of the protocol data unit. An example scenario of sub-aspect 1.1.1 is illustrated in FIG. 6, example acts or steps comprising an example implementation of the scenario of FIG. 6 are shown in FIG. 7, and FIG. 8 shows an example communications system configured to implement the scenario of FIG. 6.

FIG. 6 depicts a sub-aspect of the technology disclosed herein which determines the priority of an uplink grant for retransmission when dynamic priority is used. A receiver node which serves as a receiver node, such as a base station, can configure two LCH priority values for each logical channel. The two priority values are configured by an RRC message transmitted by a base station to a node which serves as a transmitter node, such as a wireless terminal, e.g., UE. In the example of FIG. 6, the first priority value of LCH1 is 10 which is used when there is no available data with remaining time less than a threshold for this LCH. The second priority is 3 which is used when there is available data with remaining time less than a threshold for this LCH. When a packet arrives in the UE, the packet is not considered as urgent data. The example assumes the packet has not been transmitted until the remaining time is smaller than a remaining time threshold. Once there is a packet with remaining timer smaller than the threshold, the logical channel priority is changed to the second priority, e.g., priority 3, high priority, which is used in LCP. Meanwhile, the packet is included in a MAC PDU, Medium Access Control Protocol Data Unit, multiplexing data from at least one of LCHs, data from LCH1 with priority 3 and data from other logical channel with priority 11 are multiplexed in FIG. 6. As the urgent data has been transmitted or included in the MAC PDU, the priority is going back to the first priority, e.g., priority 10. The priority of an uplink grant for initial transmission is 3, which is highest priority of LCHs multiplexed in the MAC PDU. The priority 3 is based on the LCH priority at the time of LCP procedure for the MAC PDU.

In the example of FIG. 6, the base station assigns a retransmission resource for the same MAC PDU. For the retransmission, the priority of an uplink grant is determined by the highest LCH priority of data multiplexed in the MAC PDU. At this time, the LCH priority of LCH1 is 10, the first priority. However, the packet was included in the MAC PDU when its LCH priority was 3. Thus, LCH priority 3 represents LCH1 for the retransmission resource. In some exemplary embodiment, the same uplink grant priority is assumed for both initial transmission and retransmission. In any case, the priority of the uplink grant for the retransmission becomes 3. In the example, there is an overlapped uplink grant in time domain, which has data from an LCH with priority 7. Thus, the priority of the overlapped uplink grant is 7. So, the uplink grant with priority 3 is prioritized, delivered to the lower layer, e.g., physical layer, and transmitted to the base station. The other overlapped grant with priority 7 is de-prioritized and not delivered to the lower layer. Hence, an uplink grant for retransmission which can transmit higher priority data can be prioritized, and its higher priority is kept regardless of the change of LCH priority depending on buffered data not transmitted at the time.

Example acts or steps comprising an example implementation of the scenario of FIG. 6 are shown in FIG. 7. The acts of FIG. 7 are essentially the same as correspondingly suffix-numbered acts of FIG. 4, except that Act 7-3 comprises the receiver node, after receiving the message M, making a determination of priority of a transmission grant for retransmission of the protocol data unit as being dependent on the determination of priority of the transmission grant for an initial transmission of the protocol data unit.

FIG. 8 shows a communications system which comprises a network node NN and a wireless terminal UE which may be utilized to implement the scenario of FIG. 6 and acts of FIG. 7. Again it should be understood that herein “network” may be used interchangeably with “network node”, except where otherwise clear from the context. In an example embodiment and mode, the structures and functionalities of FIG. 8 may be essentially the same as those of FIG. 5, with an exception being that the priority determination controller 72.1.1 of FIG. 8 is configured to make a determination of priority of a transmission grant for retransmission of the protocol data unit as being dependent on the determination of priority of the transmission grant for an initial transmission of the protocol data unit.

While FIG. 7 and FIG. 8 have shown the transmitter node to be a wireless terminal such as UE 30 and the receiver node to be a network node such as base station node 26, it should also be understood that the roles may be inverted for some communications systems, e.g., the wireless terminal may serve as the receiver node and the network node may serve as the transmitter node.

### 1.1.2 Determination for Retransmission Based on Same Based on Present Logical Channel Priority

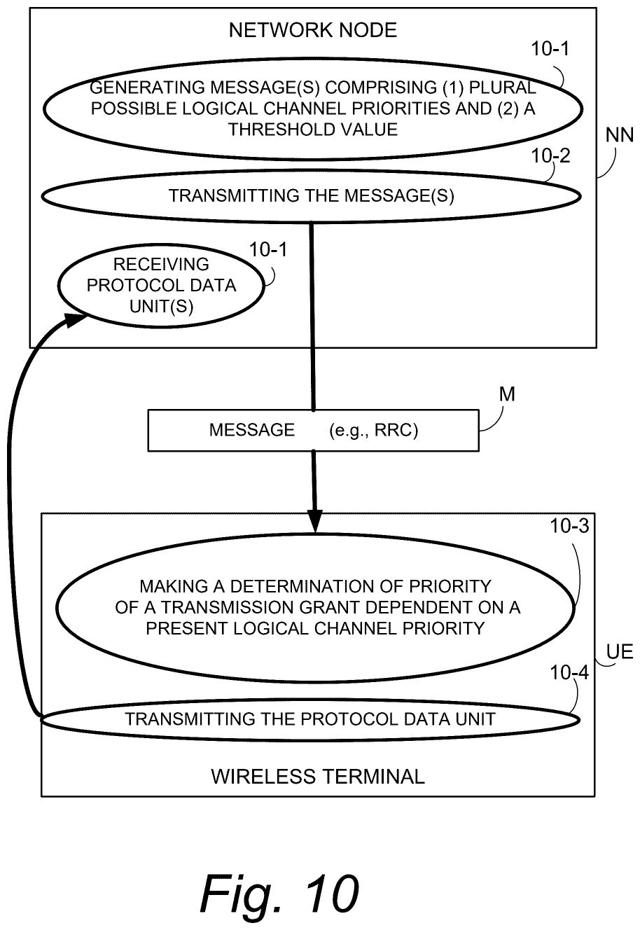

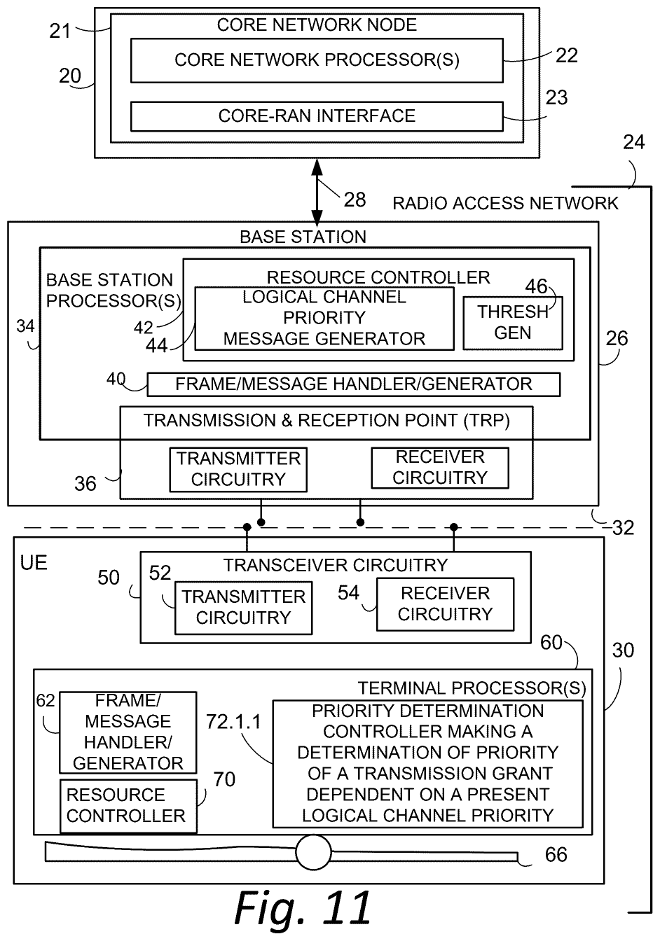

Sub-aspect 1.1.2 encompasses an example scenario of dynamic LCH priority in which, for retransmission of a protocol data unit, a current LCH priority can be used. For example, sub-aspect 1.1.2 encompasses a determination of priority of a transmission grant for retransmission of the protocol data unit dependent on a present logical channel priority. An example scenario of sub-aspect 1.1.2 is illustrated in FIG. 9, example acts or steps comprising an example implementation of the scenario of FIG. 9 are shown in FIG. 10, and FIG. 11 shows an example communications system configured to implement the scenario of FIG. 9.

FIG. 9 depicts one of the proposed methods, e.g., sub-aspect 1.1.2, in which the priority of an uplink grant for retransmission when dynamic priority is used is determined. A node which serves as a receiver node, such as a base station, can configure two LCH priority values for each logical channel. The two priority values are configured by an RRC message transmitted by a base station to a node which serves as a transmitter node, such as wireless terminal, e.g., UE. In the example, the first priority value of LCH1 is 10 which is used when there is no available data with remaining time less than a threshold for this LCH. The second priority is 3 which is used when there is available data with remaining time less than a threshold for this LCH. When a packet arrives in the UE, the packet is not considered as urgent data. The example assumes the packet has not been transmitted until the remaining time is smaller than a remaining time threshold. Once there is a packet with remaining timer smaller than the threshold, the logical channel priority is changed to the second priority, e.g., priority 3. high priority, which is used in LCP. Meanwhile, the packet is included in a MAC PDU, Medium Access Control Protocol Data Unit, multiplexing data from at least one of LCHs (data from LCH1 with priority 3 and data from other logical channel with priority 11 are multiplexed in FIG. 9. As the urgent data has been transmitted or included in the MAC PDU, the priority is going back to the first priority, i.e., priority 10. The priority of an uplink grant for initial transmission is 3, which is highest priority of LCHs multiplexed in the MAC PDU. Priority 3 is based on the LCH priority at the time of LCP procedure for the MAC PDU.

In the example of FIG. 9, the base station assigns a retransmission resource for the same MAC PDU. For the retransmission, the priority of an uplink grant is determined by the highest LCH priority of data multiplexed in the MAC PDU. At this time, the LCH priority of LCH1 is 10, the first priority. LCP procedure for the MAC PDU was performed long time ago, the UE may not store the LCH priority at the time of LCP. In this case, the present LCH priority can be used to determine the priority of an uplink grant for retransmission. LCH1's packet was included in the MAC PDU when its LCH priority was 3, but its present priority is 10. LCH priority 10 represents LCH1 for the retransmission resource. In any case, the priority of the uplink grant for the retransmission becomes 10. In the example, there is an overlapped uplink grant in time domain, which has data from an LCH with priority 7. Thus, the priority of the overlapped uplink grant is 7. So, the uplink grant with priority 10 is de-prioritized and not delivered to the lower layer, e.g., physical layer. The other overlapped grant with priority 7 is prioritized, delivered to the lower layer and transmitted to the base station. This method does not require to store the LCH priority used for the initial transmission, so UE implementation can be simpler.

In another exemplary embodiment, the UE may always use the present LCH priority regardless of LCH priority at the time of LCP. Under this assumption, the priority of the uplink grant is 10 for both initial transmission and retransmission. This can also reduce UE implementation complexity.

Example acts or steps comprising an example implementation of the scenario of FIG. 9 are shown in FIG. 10. The acts of FIG. 10 are essentially the same as correspondingly suffix-numbered acts of FIG. 4, except that Act 10-3 comprises the receiver node, after receiving the message M, making a determination of priority of a transmission grant for retransmission of the protocol data unit as being dependent on a present logical channel priority.

FIG. 11 shows a communications system which comprises a network node NN and a wireless terminal UE which may be utilized to implement the scenario of FIG. 9 and acts of FIG. 10. Again it should be understood that herein “network” may be used interchangeably with “network node”, except where otherwise clear from the context. In an example embodiment and mode, the structures and functionalities of FIG. 11 may be essentially the same as those of FIG. 5, with an exception being that the priority determination controller 72.1.2 of FIG. 11 is configured to make a determination of priority of a transmission grant for retransmission of the protocol data unit as being dependent on a present logical channel priority.

While FIG. 10 and FIG. 11 have shown the transmitter node to be a wireless terminal such as UE 30 and the receiver node to be a network node such as base station node 26, it should also be understood that the roles may be inverted for some communications systems, e.g., the wireless terminal may serve as the receiver node and the network node may serve as the transmitter node.

### 1.2 Determination Based on Static Logical Channel Priority

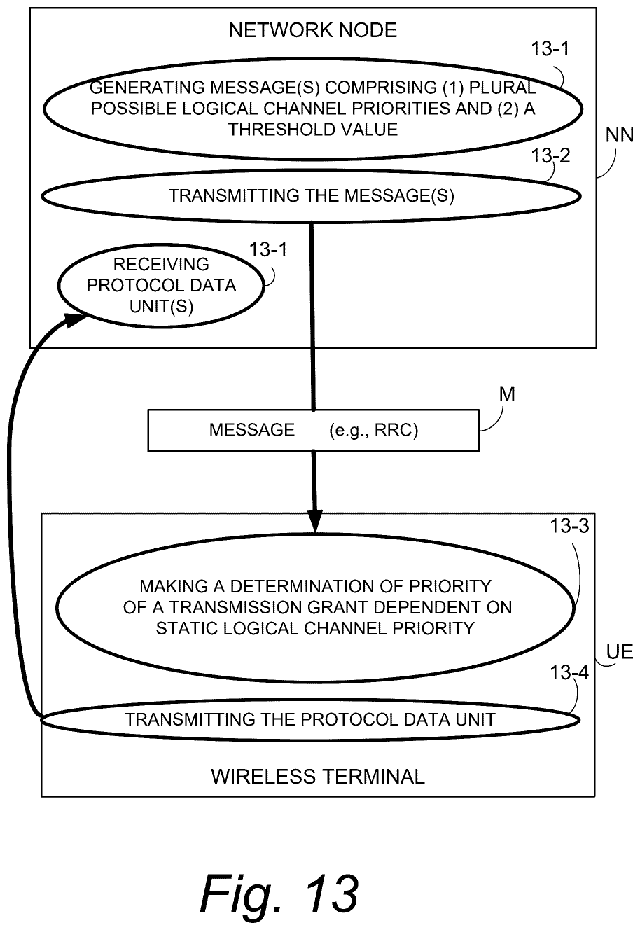

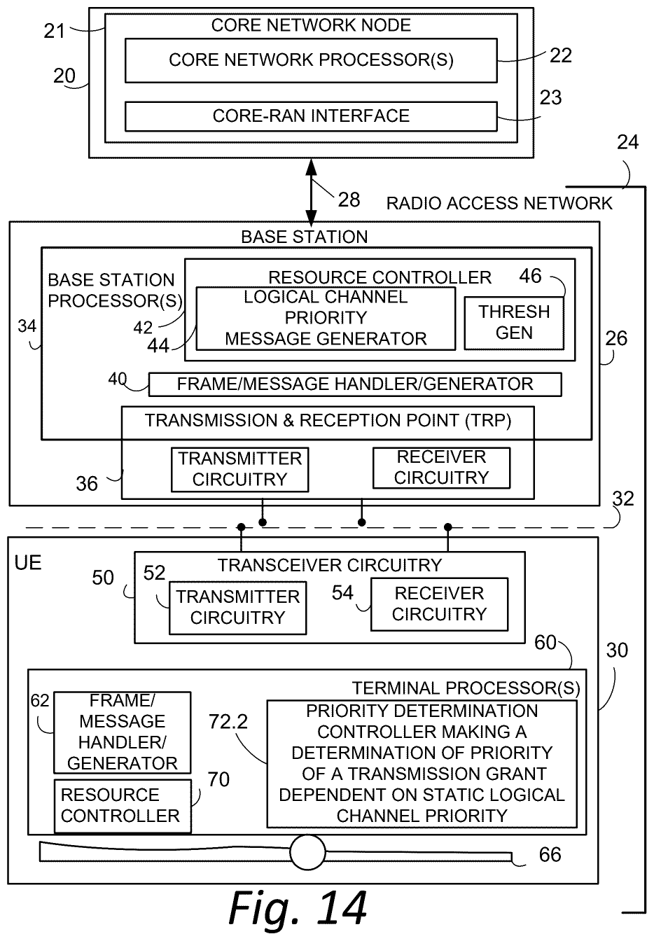

Sub-aspect 1.2 encompasses an example scenario of dynamic LCH priority in which a first priority, e.g., legacy LCH priority, is always used. For example, sub-aspect 1. 2 encompasses a determination of priority of a transmission grant based on a static logical channel priority. For example, the determination may be made based on a predetermined one of plural possible logical channel priorities. An example scenario of sub-aspect 1. 2 is illustrated in FIG. 12, example acts or steps comprising an example implementation of the scenario of FIG. 12 are shown in FIG. 13, and FIG. 14 shows an example communications system configured to implement the scenario of FIG. 12.

FIG. 12 depicts one of the proposed methods, e.g., sub-aspect 1.2, in determine the priority of an uplink grant when dynamic priority is used is determined. A nod which serves as a receiver node, such as a base station, can configure two LCH priority values for each logical channel. The two priority values are configured by an RRC message transmitted by a base station to a node which serves as a transmitter node, such as to a wireless terminal, e.g., UE. In the example, the first priority value of LCH1 is 10 which is used when there is no available data with remaining time less than a threshold for this LCH. The second priority is 3 which is used when there is available data with remaining time less than a threshold for this LCH. When a packet arrives in the UE, the packet is not considered as urgent data. The example assumes the packet has not been transmitted until the remaining time is smaller than a remaining time threshold. Once there is a packet with remaining timer smaller than the threshold, the logical channel priority is changed to the second priority, e.g., priority 3, high priority, which is used in LCP. Meanwhile, the packet is included in a MAC PDU, Medium Access Control Protocol Data Unit, multiplexing data from at least one of LCHs, e.g., data from LCH1 with priority 3 and data from other logical channel with priority 11 are multiplexed in FIG. 12). As the urgent data has been transmitted or included in the MAC PDU, the priority is going back to the first priority, i.e., priority 10.

In the exemplary embodiment of FIG. 12-FIG. 14, when a UE determines the priority of an uplink grant, only the first priority value is considered regardless of the present LCH priority or LCH priority used in LCP for the MAC PDU. In the example, the priority of the uplink grant is determined as 10, which is the highest LCH priority among data from LCHs having data which are multiplexed in the MAC PDU. For LCH1, priority value 10, the first priority, is used. In the example, there is an overlapped uplink grant in time domain, which has data from an LCH with priority 7. Thus, the priority of the overlapped uplink grant is 7. So, the uplink grant with priority 10 is de-prioritized and not delivered to the lower layer, e.g., physical layer. The other overlapped grant with priority 7 is prioritized, delivered to the lower layer and transmitted to the base station. This method does not require to check the present LCH priority value, so UE implementation can be simpler.

In another exemplary embodiment, the UE may always use the second priority value regardless of the present LCH priority or LCH priority used in LCP for the MAC PDU. Under this assumption, the priority of the uplink grant is always 10 regardless of dynamic LCH priority. This can also reduce UE implementation complexity. In another exemplary embodiment, an LCH priority value used for determining the priority of an uplink grant can be configured by the base station to the UE via an RRC message.

Example acts or steps comprising an example implementation of the scenario of FIG. 12 are shown in FIG. 13. The acts of FIG. 13 are essentially the same as correspondingly suffix-numbered acts of FIG. 4, except that Act 13-3 comprises the receiver node, after receiving the message M, making a determination of priority of a transmission grant as being dependent on a static logical channel priority, as understood with reference to FIG. 12.

FIG. 14 shows a communications system which comprises a network node NN and a wireless terminal UE which may be utilized to implement the scenario of FIG. 12 and acts of FIG. 13. Again it should be understood that herein “network” may be used interchangeably with “network node”, except where otherwise clear from the context. In an example embodiment and mode, the structures and functionalities of FIG. 14 may be essentially the same as those of FIG. 5, with an exception being that the priority determination controller 72.2 of FIG. 14 is configured to make a determination of priority of a transmission grant as being dependent on a static logical channel priority.

While FIG. 13 and FIG. 14 have shown the transmitter node to be a wireless terminal such as UE 30 and the receiver node to be a network node such as base station node 26, it should also be understood that the roles may be inverted for some communications systems, e.g., the wireless terminal may serve as the receiver node and the network node may serve as the transmitter node.

### 1.3 Determination Based on Data in PDU

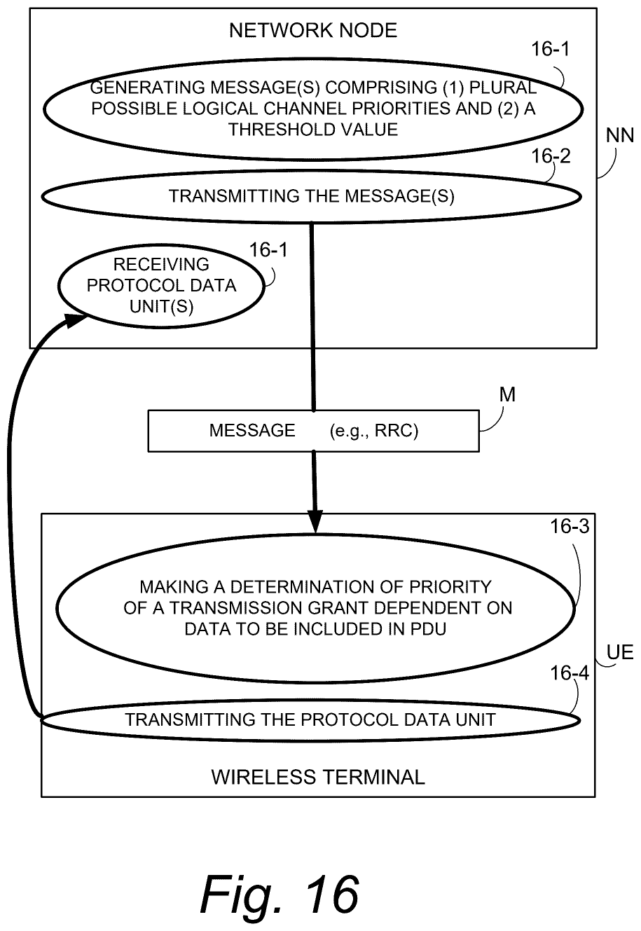

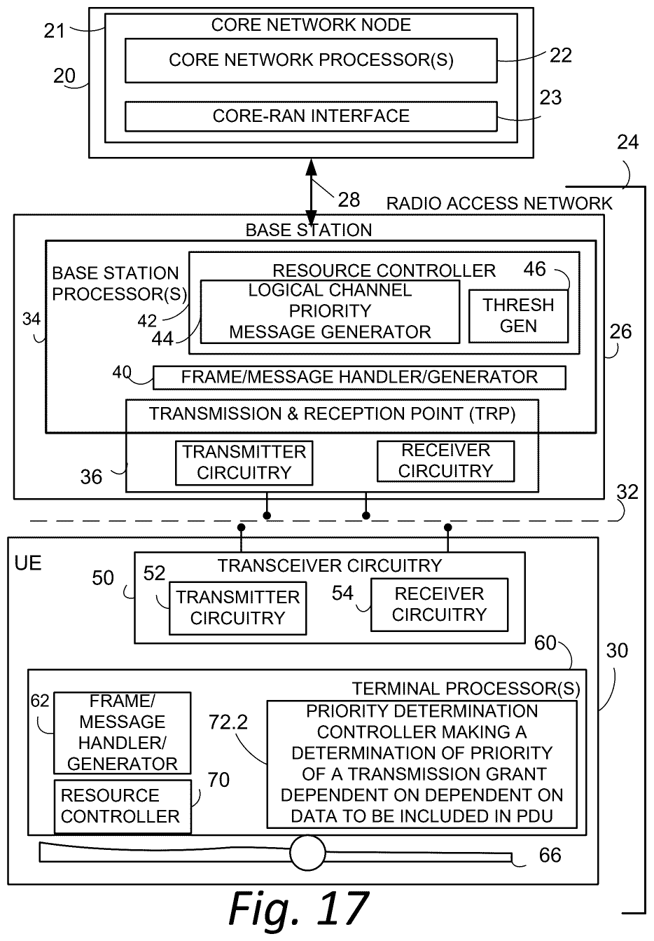

Sub-aspect 1.3 encompasses an example scenario of dynamic LCH priority in which, if a LCH data multiplexed in the MAC PDU includes the data with remaining time less than the threshold, a second priority, e.g., enhanced priority, is used. For example, sub-aspect 1. 2 encompasses a determination of priority of a transmission grant which is based dependent on data to be included in the protocol data unit for the transmission grant. An example scenario of sub-aspect 1. 3 is illustrated in FIG. 15, example acts or steps comprising an example implementation of the scenario of FIG. 15 are shown in FIG. 16, and FIG. 17 shows an example communications system configured to implement the scenario of FIG. 13.

FIG. 15 depicts one of the proposed methods, e.g., sub-aspect 1.3, which determine the priority of an uplink grant when dynamic priority is used. Sub-aspect 1.3 encompasses that priority of each uplink grant depends on the data included in the MAC PDU transmitted by the uplink grant. More specifically, if the MAC PDU can include data with remaining time smaller than a threshold, the second LCH priority is used to determine the priority of the uplink grant. In contrast, if the MAC PDU does not include data with remaining time smaller than a threshold, the first LCH priority is used. The time point used for the calculation of the remaining time can be either PDCCH reception time or PUSCH transmission time. If a MAC PDU is retransmitted, the PDCCH reception time or PUSCH transmission time could be different from that of the initial transmission, the LCH priority used for determining the priority of the uplink grant can be different.

A node which serves as a receiver node, such as a network node, for example, can configure two LCH priority values for each logical channel. The two priority values are configured by an RRC message transmitted by the receiver node to a node which serves as a transmitter node, such as a wireless terminal, UE. In the example, the first priority value of LCH1 is 10 which is used when there is no available data with remaining time less than a threshold for this LCH. The second priority is 3 which is used when there is available data with remaining time less than a threshold for this LCH. When a packet arrives in the UE, the packet is not considered as urgent data. The example assumes the packet is initial transmitted when the first LCH priority (p=10) is used, i.e., the remaining time is not smaller than a remaining time threshold. When the initial transmission is performed, data from LCH1 is not urgent, i.e., no data with remaining time smaller than a threshold. Thus, LCH priority 10 represents LCH1, so the priority of an uplink grant is 10. Later, the base station assigns a retransmission resource for the same MAC PDU. For the retransmission, the priority of an uplink grant is determined by the highest LCH priority of data multiplexed in the MAC PDU. At the time of retransmission, the data from LCH1 becomes urgent, as its remaining time is smaller than a threshold. In this case, the second priority (p=3) is used to determine the priority of the uplink grant, regardless of the present LCH priority of LCH1 which is 10 as the urgent data was already multiplexed in the MAC PDU. In the example, there is an overlapped uplink grant in time domain, which has data from an LCH with priority 7. Thus, the priority of the overlapped uplink grant is 7. So, the uplink grant with priority 3 is prioritized, delivered to the lower layer, e.g., physical layer, and transmitted to the base station. The other overlapped grant with priority 7 is de-prioritized and not delivered to the lower layer. Hence, an uplink grant which can transmit higher priority data can be prioritized, and its higher priority is kept regardless of the change of LCH priority depending on buffered data not transmitted at the time.

Example acts or steps comprising an example implementation of the scenario of FIG. 15 are shown in FIG. 16. The acts of FIG. 16 are essentially the same as correspondingly suffix-numbered acts of FIG. 4, except that Act 16-3 comprises the receiver node, after receiving the message M, making a determination of priority of a transmission grant as being dependent on data to be included in the protocol data unit for the transmission grant.

FIG. 17 shows a communications system which comprises a network node NN and a wireless terminal UE which may be utilized to implement the scenario of FIG. 15 and acts of FIG. 16. Again it should be understood that herein “network” may be used interchangeably with “network node”, except where otherwise clear from the context. In an example embodiment and mode, the structures and functionalities of FIG. 17 may be essentially the same as those of FIG. 5, with an exception being that the priority determination controller 72.3 of FIG. 17 is configured to make a determination of priority of a transmission grant as being dependent on data to be included in the protocol data unit for the transmission grant.

While FIG. 16 and FIG. 17 have shown the transmitter node to be a wireless terminal such as UE 30 and the receiver node to be a network node such as base station node 26, it should also be understood that the roles may be inverted for some communications systems, e.g., the wireless terminal may serve as the receiver node and the network node may serve as the transmitter node.

### 2.0 BSR Triggering Condition Considering Dynamic LCG Priority

A Buffer Status Report (BSR) is a MAC CE transmitted from a node which serves as a transmitter node e.g., a wireless terminal such as a UE, to node which serves as a receiver node, such as a base station, e.g., gNB in 5G communications systems. A buffer status report indicates the buffer size for each logical channel group, LCG, consisting of one or multiple logical channels. From triggering perspective, there are three types of BSR [TS 38.321]:
Regular BSR: When uplink, UL, data becomes available, e.g., new data arrives in the UE or Packet Data Convergence Protocol (PDCP) layer indicates the presence of the available data as data volume, and this UL data belongs to a logical channel with higher priority than the priority of any logical channel containing available UL data which belong to any LCG or none of the logical channels which belong to an LCG contains any available UL data, a BSR is triggered and transmitted. This BSR is referred to as a ‘Regular BSR.’ Also, when a timer known as retxBSR-Timer expires, and at least one of the logical channels which belong to an LCG contains UL data, a BSR is triggered and transmitted. This BSR is referred to as a ‘Regular BSR.’
Periodic BSR: When a timer known as periodicBSR-Timer expires, a BSR is triggered and transmitted. This BSR is referred to as ‘Periodic BSR’
Padding BSR: When UL resources are allocated and number of padding bits is equal to or larger than the size of the BSR MAC CE plus its subheader. a BSR MAC CE is triggered and transmitted. This BSR is referred to as ‘Padding BSR.’
   Except for the retxBSR-Timer expiry, a regular BSR is triggered only if new data becomes available. The reason for this condition is that this event is the only case that the highest LCH priority among LCHs having available data is changed, under the assumption that LCH priority does not change. However, if dynamic LCH priority is assumed, there will be other cases that the highest LCH priority among LCHs having available data is changed. Various example cases are addressed as aspects 2.1, 2.2, and 2.3 of the technology disclosed herein.

### 2.1 BSR Generated Upon Occurrence of a Logical Channel Priority Change

Sub-aspect 2.1 encompasses an example scenario of dynamic LCH priority in which a buffer status report is triggered or generated upon occurrence of a logical channel priority change. Unlike some various other sub-aspects described herein, in sub-aspect the buffer status report is trigger upon essentially any occurrence of a logical channel priority change, e.g., increase or decrease of logical channel priority change, although in some example implementations it may be required for consecutive buffer status report to be separated by a time interval. An example scenario of sub-aspect 1. 3 is illustrated in FIG. 15, example acts or steps comprising an example implementation of the scenario of FIG. 15 are shown in FIG. 16, and FIG. 17 shows an example communications system configured to implement the scenario of FIG. 13.

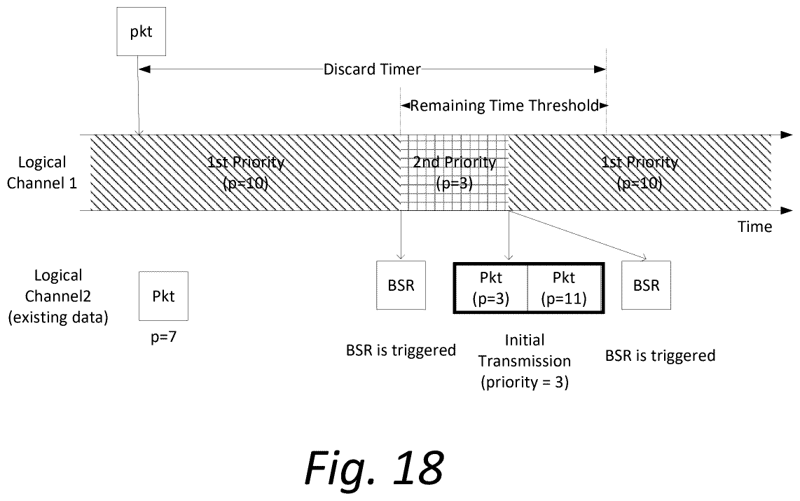

FIG. 18 depicts a BSR triggering procedure based on LCH priority change. A node which serves as a receiver node, such as a base station, can configure two LCH priority values for each logical channel. The two priority values are configured by an RRC message transmitted by the base station to a node which serves as a transmitter node, such as a wireless terminal, UE. In the example of FIG. 18, the first priority value of LCH1 is 10 which is used when there is no available data with remaining time less than a threshold for this LCH. The second priority is 3 which is used when there is available data with remaining time less than a threshold for this LCH. It is assumed that LCH2 has only one priority value which is 7. At the beginning of the example of FIG. 18, it is assumed that only LCH2 with priority 7 has available data in the buffer. The highest LCH priority at this time is 7. Later, a packet for LCH1 arrives in the UE. When the packet arrives in the UE, the packet is not considered as urgent data. At the time of arrival of the packet, LCH1 does not have any urgent data, so the priority of LCH1 is 10. The example assumes the packet has not been transmitted until the remaining time is smaller than a remaining time threshold. Once there is a packet with remaining timer smaller than the threshold, the logical channel priority is changed to the second priority, i.e., priority 3, i.e., high priority.

In the case of FIG. 18, the base station needs to know that the priority of LCH1 is changed. According to sub-aspect 2.1, the UE's MAC entity triggers a BSR and transmits it to the base station. When UL data, for a logical channel which belongs to an LCG, is currently available to the MAC entity and the priority of the logical channel has been changed, a BSR can be triggered. This BSR can be classified as a Regular BSR. In another exemplary embodiment, when the priority of an LCH having available data has been changed regardless of presence of available data, a BSR can be triggered.

In the example of FIG. 18, after the urgent data from LCH1 is transmitted as an initial transmission, LCH1's priority is changed to the first priority (priority 10). In this case, another BSR is triggered as priority of LCH1 has been changed.

Too frequent BSR transmissions may be considered as resource waste. To avoid the too frequent BSR transmissions, a prohibit timer operation may be considered. The prohibit timer can be started upon a BSR transmission with one of particular types, e.g., a BSR with one of particular types is included in a MAC PDU. When the prohibit timer is running, the BSR is not multiplexed in the MAC PDU even if there is at least one triggered BSR. Thus, the wireless terminal, e.g., a processor circuitry of the wireless terminal, is configured to generate a subsequent buffer status report only after lapse of a predetermined time.

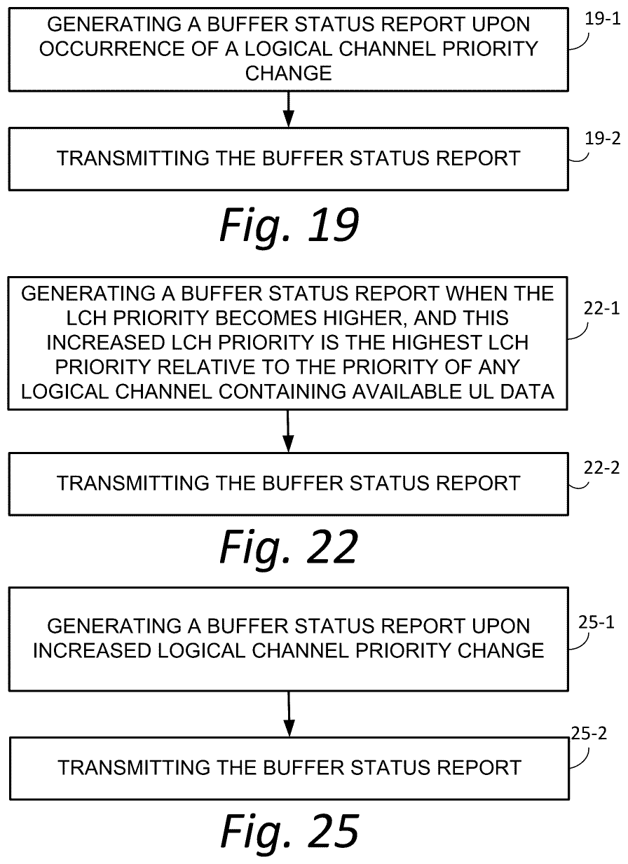

FIG. 19 shows example, representative, generic acts or steps that may be performed by a transmitter node in a communications system which comprises both the transmitter node and a receiver node. The transmitter node may be a wireless terminal such as a UE and the receiver node may be a network node NN such as a radio access network node or a core network node. The roles of the nodes may be reversed in at least some operations, so that the network node may be the transmitter node and the wireless terminal may be the receiver node. Act 19-1 comprises the transmitter node generating a buffer status report upon occurrence of a logical channel priority change. Act 19-2 comprises the transmitter node transmitting the buffer status report across a radio interface to another node of the system, e.g., to the receiver node.

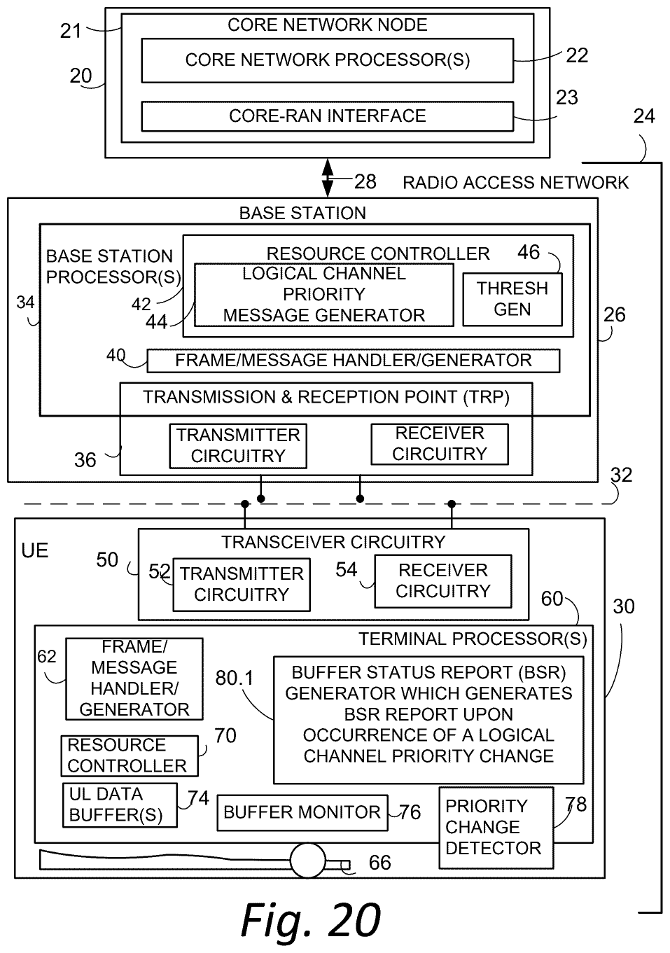

FIG. 20 shows a communications system which comprises a network node NN and a wireless terminal UE which may be utilized to implement the scenario of FIG. 18 and acts of FIG. 19. Again it should be understood that herein “network” may be used interchangeably with “network node”, except where otherwise clear from the context. In an example embodiment and mode, the structures and functionalities of FIG. 20 may be essentially the same as those of FIG. 5 and to include the further structures and functionalities shown in FIG. 20. Although the logical channel priority message generator 44 and threshold value message generator 46 of the resource controller 42 of the network node are not illustrated in FIG. 20 for sake of simplicity, such elements may indeed be included as shown in FIG. 5 and/or other embodiments.

FIG. 20 further shows that the wireless terminal 30 comprises uplink data buffer(s) 74, buffer monitors 76 that detect presence of available data and the amount of available data in the uplink data buffer(s) 74; logical channel priority change detector 78; and buffer status report generator 80. The buffer status report generator 80 is particularly shown as buffer status report generator 80.1 to correspond to sub-aspect 2.1 and is configured to generate a buffer status report upon occurrence of a logical channel priority change. The buffer status report generator 80.1, and other structures, may be included in or comprise a medium access control, MAC, entity.

The buffer status report generator 80.1 may include a buffer status report formatter that includes an indication, such as a bit, that reflects that the buffer status report is being generated occurrence of a logical channel priority change.

FIG. 20 further shows that the base station processors 34 of a node that serves as the receiver node may include a buffer status report monitor 90. The buffer status report monitor 90 may include logic to determine whether the buffer status report was generated upon occurrence of a logical channel priority change.

While FIG. 20 has shown the transmitter node to be a wireless terminal such as UE 30 and the receiver node to be a network node such as base station node 26, it should also be understood that the roles may be inverted for some communications systems, e.g., the wireless terminal may serve as the receiver node and the network node may serve as the transmitter node.

### 2.2 BSR Generated When LCH Priority Becomes Higher Than Other LCHs With Available Data

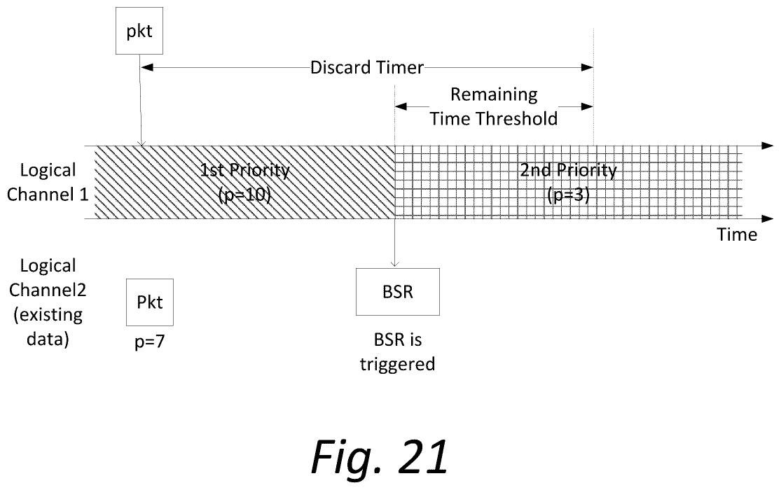

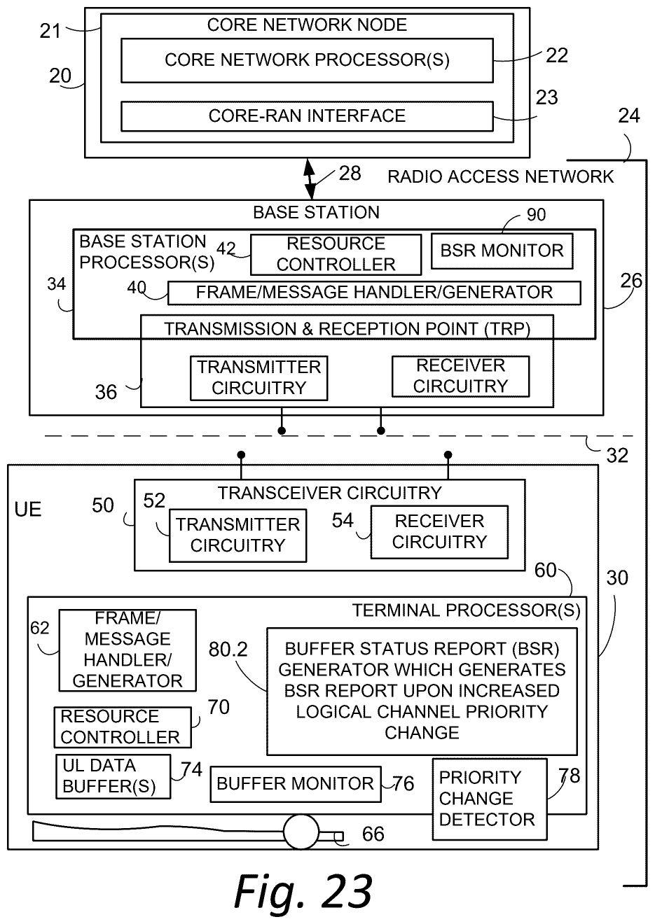

Sub-aspect 2.2 encompasses an example scenario of dynamic LCH priority in which a buffer status report is triggered or generated when the LCH priority becomes higher, e.g., the priority becomes greater or is increased, and this increased LCH priority is the highest LCH priority relative to the priority of any logical channel containing available UL data. An example scenario of sub-aspect 2.2 is illustrated in FIG. 21, example acts or steps comprising an example implementation of the scenario of FIG. 21 are shown in FIG. 22, and FIG. 23 shows an example communications system configured to implement the scenario of FIG. 21.

FIG. 21 depicts a BSR triggering procedure based on LCH priority change. A node which serves as a receiver node, such as a network node, e.g., a base station, can configure two LCH priority values for each logical channel. The two priority values are configured by an RRC message transmitted by the receiver node to a node which serves as a transmitter node, e.g., a wireless terminal, UE. In the example of FIG. 21, the first priority value of LCH1 is 10 which is used when there is no available data with remaining time less than a threshold for this LCH. The second priority is 3 which is used when there is available data with remaining time less than a threshold for this LCH. It is assumed that LCH2 has only one priority value which is 7. At the beginning of the example of FIG. 21, it is assumed that only LCH2 with priority 7 has available data in the buffer. The highest LCH priority at this time is 7. Later, a packet for LCH1 arrives in the UE. When the packet arrives in the UE, the packet is not considered as urgent data. At the time of arrival of the packet, LCH1 does not have any urgent data, so the priority of LCH1 is 10. The example assumes the packet has not been transmitted until the remaining time is smaller than a remaining time threshold. Once there is a packet with remaining timer smaller than the threshold, the logical channel priority is changed to the second priority, i.e., priority 3 (high priority). Then, LCH1 becomes the highest priority LCH which has available data and the priority of LCH1 is higher than any logical channel having available data.

In the case of FIG. 21, the base station needs to know the presence of data from the LCH which newly becomes the highest priority logical channel having available data. According to sub-aspect 2.2, the UE's MAC entity triggers a BSR and transmits it to the base station. When UL data, for a logical channel which belongs to an LCG, is currently available to the MAC entity and the priority of the logical channel was not the highest priority than the priority of any logical channel containing available UL data belong to any LCG and the priority of the logical channel becomes the highest priority than the priority of any logical channel containing available UL data belongs to any LCGs except the LCH itself, a BSR can be triggered. This BSR can be classified as a Regular BSR. In another exemplary embodiment, when the priority of an LCH having available data has been changed to higher priority among two priorities and the priority of the logical channel was not the highest priority than the priority of any logical channel containing available UL data belong to any LCG and the priority of the logical channel becomes the highest priority than the priority of any logical channel containing available UL data belongs to any LCGs except the LCH itself, a BSR can be triggered.

Too frequent BSR transmissions may be considered as resource waste. To avoid the too frequent BSR transmissions, a prohibit timer operation may be considered. The prohibit timer can be started upon a BSR transmission with one of particular types (i.e., a BSR with one of particular types is included in a MAC PDU). When the prohibit timer is running, the BSR is not multiplexed in the MAC PDU even if there is at least one triggered BSR.

FIG. 22 shows example, representative, generic acts or steps that may be performed by a transmitter node in a communications system which comprises both the transmitter node and a receiver node. The transmitter node may be a wireless terminal such as a UE and the receiver node may be a network node NN such as a radio access network node or a core network node. The roles of the nodes may be reversed in at least some operations, so that the network node may be the transmitter node and the wireless terminal may be the receiver node. Act 22-1 comprises the transmitter node generating a buffer status report when the LCH priority becomes higher, e.g., the priority becomes greater or is increased, and this increased LCH priority is the highest LCH priority relative to the priority of any logical channel containing available UL data. Act 22-2 comprises the transmitter node transmitting the buffer status report across a radio interface to another node of the system, e.g., to the receiver node.

FIG. 20 shows a communications system which comprises a network node NN and a wireless terminal UE which may be utilized to implement the scenario of FIG. 21 and acts of FIG. 22. In an example embodiment and mode, the structures and functionalities of FIG. 20 may be essentially the same as those of FIG. 20, except that in FIG. 23 buffer status report generator 80 is particularly shown as buffer status report generator 80.2 to correspond to sub-aspect 2.2 and is configured to generate a buffer status report when the LCH priority becomes higher, e.g., the priority becomes greater or is increased, and this increased LCH priority is the highest LCH priority relative to the priority of any logical channel containing available UL data. The buffer status report generator 80.2, and other structures, may be included in or comprise a medium access control, MAC, entity.

While FIG. 23 has shown the transmitter node to be a wireless terminal such as UE 30 and the receiver node to be a network node such as base station node 26, it should also be understood that the roles may be inverted for some communications systems, e.g., the wireless terminal may serve as the receiver node and the network node may serve as the transmitter node.

### 2.3 BSR Generated When LCH Priority is Change to Higher Priority

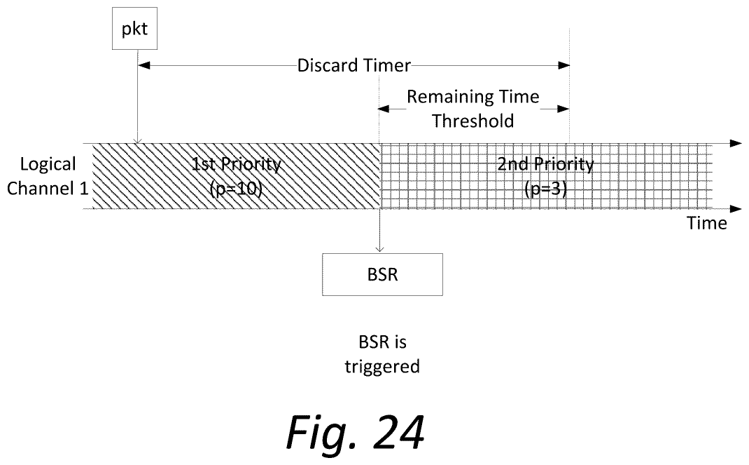

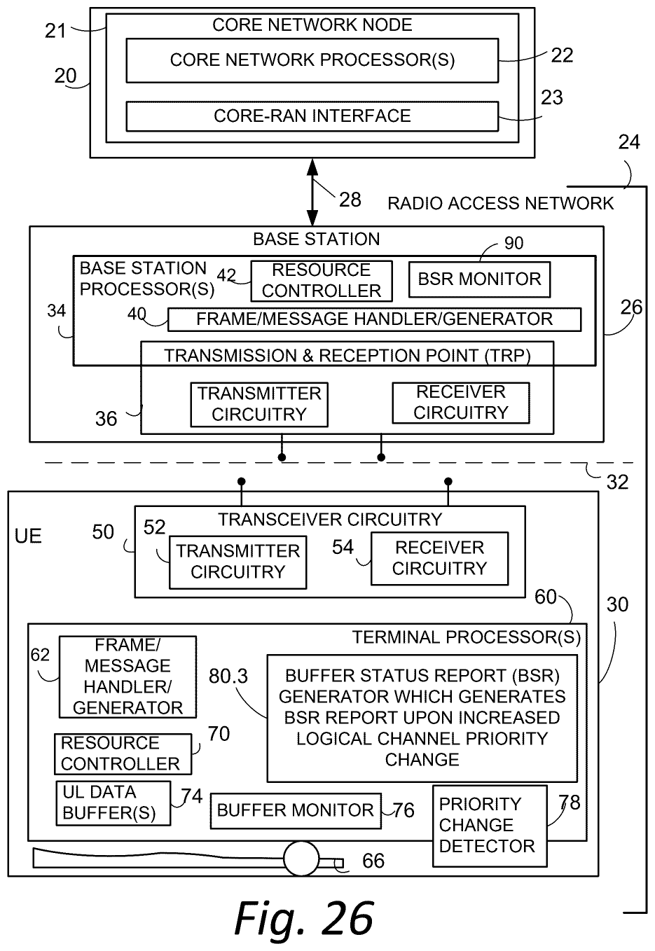

Sub-aspect 2.3 encompasses an example scenario of dynamic LCH priority in which a buffer status report is triggered or generated when a LCH priority is changed to a higher priority. The sub-aspect 2.3 encompasses generation of the buffer status report when a LCH priority is changed and a remaining time has become smaller than a threshold. An example scenario of sub-aspect 2.3 is illustrated in FIG. 24, example acts or steps comprising an example implementation of the scenario of FIG. 24 are shown in FIG. 25, and FIG. 26 shows an example communications system configured to implement the scenario of FIG. 24.

FIG. 24 depicts a BSR triggering procedure based on LCH priority change according to sub-aspect 2.3. A node which serves as a receiver node, such as a base station, can configure two LCH priority values for each logical channel. The two priority values are configured by an RRC message transmitted by the node which serves as the receiving node, e.g., base station to a node which serves as a transmitter node, e.g., a wireless terminal, UE. In the example of FIG. 24, the first priority value of LCH1 is 10 which is used when there is no available data with remaining time less than a threshold for this LCH. The second priority is 3 which is used when there is available data with remaining time less than a threshold for this LCH. The example assumes the packet has not been transmitted until the remaining time is smaller than a remaining time threshold. Once there is a packet with remaining timer smaller than the threshold, the logical channel priority is changed to the second priority, e.g., priority 3, high priority.

In the case of FIG. 24, the node which serves as the receiver node, e.g., the base station, needs to know that the priority of LCH1 is changed to the higher priority. In other words, the base station needs to know that LCH1 has data available for which the remaining time has become smaller than a threshold. According to sub-aspect 2.3 of the technology disclosed herein, the UE's MAC entity triggers a BSR and transmits it to the base station. When UL data, for a logical channel which belongs to an LCG, is currently available to the MAC entity and the priority of the logical channel has been changed to the higher priority, e.g.,. the second priority, a BSR can be triggered. This BSR can be classified as a Regular BSR. In another exemplary embodiment, when any data of an LCH has remaining timer smaller than a threshold, a BSR can be triggered.

Too frequent BSR transmissions may be considered as resource waste. To avoid the too frequent BSR transmissions, a prohibit timer operation may be considered. The prohibit timer can be started upon a BSR transmission with one of particular types, e.g., a BSR with one of particular types is included in a MAC PDU. When the prohibit timer is running, the BSR is not multiplexed in the MAC PDU even if there is at least one triggered BSR.

FIG. 25 shows example, representative, generic acts or steps that may be performed by a transmitter node in a communications system which comprises both the transmitter node and a receiver node. The transmitter node may be a wireless terminal such as a UE and the receiver node may be a network node NN such as a radio access network node or a core network node. The roles of the nodes may be reversed in at least some operations, so that the network node may be the transmitter node and the wireless terminal may be the receiver node. Act 25-1 comprises the transmitter node generating a buffer status report when a LCH priority is changed to a higher priority. Act 22-2 comprises the transmitter node transmitting the buffer status report across a radio interface to another node of the system, e.g., to the receiver node.

FIG. 26 shows a communications system which comprises a network node NN and a wireless terminal UE which may be utilized to implement the scenario of FIG. 24 and acts of FIG. 25. In an example embodiment and mode, the structures and functionalities of FIG. 26 may be essentially the same as those of FIG. 20, except that in FIG. 26 buffer status report generator 80 is particularly shown as buffer status report generator 80.3 to correspond to sub-aspect 2.2 and is configured to generate a buffer status report when a LCH priority is changed to a higher priority. The buffer status report generator 80.3, and other structures, may be included in or comprise a medium access control, MAC, entity.

While FIG. 26 has shown the transmitter node to be a wireless terminal such as UE 30 and the receiver node to be a network node such as base station node 26, it should also be understood that the roles may be inverted for some communications systems, e.g., the wireless terminal may serve as the receiver node and the network node may serve as the transmitter node.

### 2.4 BSR Formats for LCH Priority Change

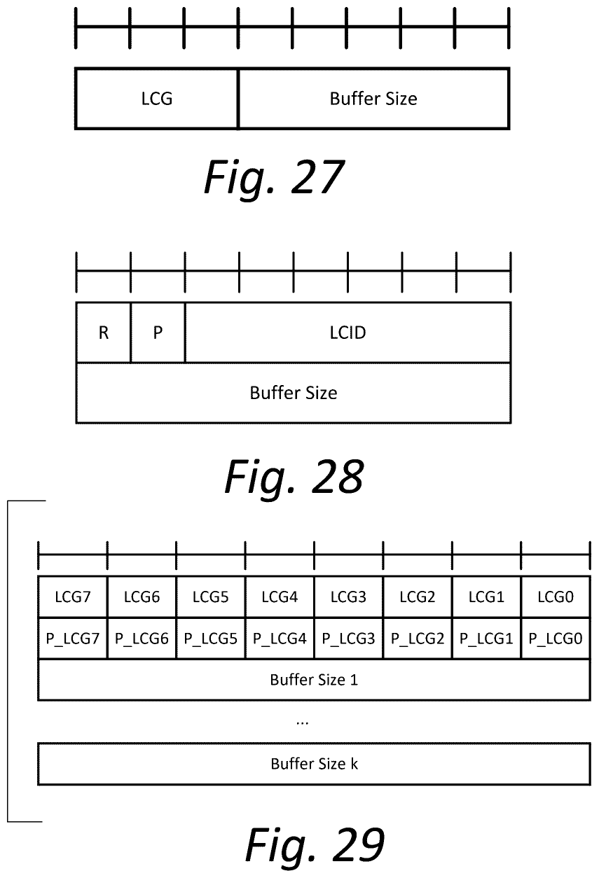

FIG. 27 depicts an example embodiment of a short buffer status report, BSR, format which can be used in case of a BSR triggered due to a LCH priority change. When a BSR is triggered due to change of LCH priority as described in FIG. 18, FIG. 21, and FIG. 24, a transmission of Long BSR with full information of all buffer sizes of the MAC entity may not be necessary and actually may be considered as a resource waste. In such case, a short BSR format such as that depicted in FIG. 27, indicating a logical channel group identifier, LCG ID, of 3-bits and a field for a buffer size of the LCG with 5-bits may be sufficient. A Buffer Size field, BS, is per logical channel “group” mapped to one or multiple logical channels. \The LCG ID field is set to the LCG ID which triggered the BSR. Based on the reception of the short BSR, the node which serves as the receiver node, e.g., a base station, can be aware of the change of LCH priority.

FIG. 28 depicts another example embodiment of a short BSR format which can be used in case of a buffer status report, BSR, triggered due to a LCH priority change. When a BSR is triggered due to change of LCH priority as described in FIG. 18, FIG. 21, and FIG. 24, a transmission of Long BSR with full information of all buffer sizes of the MAC entity may not be necessary and actually may be considered as a resource waste. Instead, the event of LCH priority change needs to be informed to the node which serves as the receiver node, e.g., the base station. Also, it would be better to indicate the logical channel with LCH priority change. For this case, the example embodiment and mode of a short BSR format in FIG. 28 consists of P field of 1-bit indicating a priority change, an LCID field indicating the logical channel ID associated with the LCH priority change, e.g., the LCID for the LCH which triggered the BSR, and a buffer size field indicating the buffer size of the LCH. An R field is a reserved field to have octet alignment. In an exemplary embodiment, a P field with value 1 indicates that a priority of the LCH has been changed, and a P field with value 0 indicates that a priority of the LCH has not been changed. In another exemplary embodiment, a P field with value 1 indicates that a priority of the LCH has been changed to a higher value, .e.g., second priority, and a P field with value 0 indicates that a priority of the LCH has been changed to a lower priority value, e.g., first priority. In some cases, the buffer size field can be optional or can be omitted. Preferably the LCG ID field is 3-bits and the buffer size field has 5-bits. The LCG ID field is set to the LCG ID which triggered the BSR. Based on the reception of the short BSR, the node which serves as the receiver node, e.g., the base station, can be aware of the change of LCH priority.

FIG. 29 depicts a long BSR format which can be used in case of a buffer status report, BSR, triggered due to a LCH priority change. When a BSR is triggered due to change of LCH priority as described in in FIG. 18, FIG. 21, and FIG. 24, a transmission of a BSR indicating buffer status for each logical channel may not be sufficient. Instead, the event of LCH priority change needs to be informed to the node which serves as the receiver node, e.g., a base station. Also, it would be better to indicate the logical channel group(s) for which LCH priority has been changed. For this case, a long BSR format shown in FIG. 29 consists of fields LCGi (i=0,1, . . . ,7) indicating LCG ID which has Buffer Size field in this long BSR, a P_LCGi field of 1-bit indicating priority change of LCH belonging to this LCG, and buffer size field indicating the buffer size of the LCG. In an exemplary embodiment, P_LCGi field with value 1 indicates that an LCH priority of the LCG has been changed, and P_LCGi field with value 0 indicates that an LCH priority of the LCG has not been changed. In another exemplary embodiment, P_LCGi field with value 1 indicates that an LCH priority of the LCG has been changed to a higher value, e.g., second priority, and P_LCGi field with value 0 indicates that an LCH priority of the LCG has been changed to a lower priority value, e.g., first priority. If LCGi field is set to 1, Buffer Size field for this logical channel group is present. Based on the reception of the long BSR, the base station can be aware of the change of LCH priority.

The buffer status reports including those described above with reference to FIG. 27, FIG. 28, and FIG. 29, for example, may be generated by the buffer status report generators described herein, including buffer status report generator 80.1, buffer status report generator 80.2, and buffer status report generator 80.3.

According to sub-aspect 3.1 the priority of SR transmission is determined by the LCH priority which triggered the SR at the time of triggering the SR. In the example of FIG. 21, the SR is triggered by a regular BSR triggered by LCH1 and LCH priority at the time of triggering the SR is 3. Thus, the priority of the SR transmission is determined as 3. In the example, the SR transmission overlaps with an uplink grant in time domain, which has data from an LCH with priority 7. Thus, the priority of the overlapped uplink grant is 7. Thus, the SR transmission is prioritized, and its transmission is indicated to the lower layer (i.e., physical layer), and the transmission is performed.

### 3.0 Determining Priority of a Scheduling Request, SR, Transmission

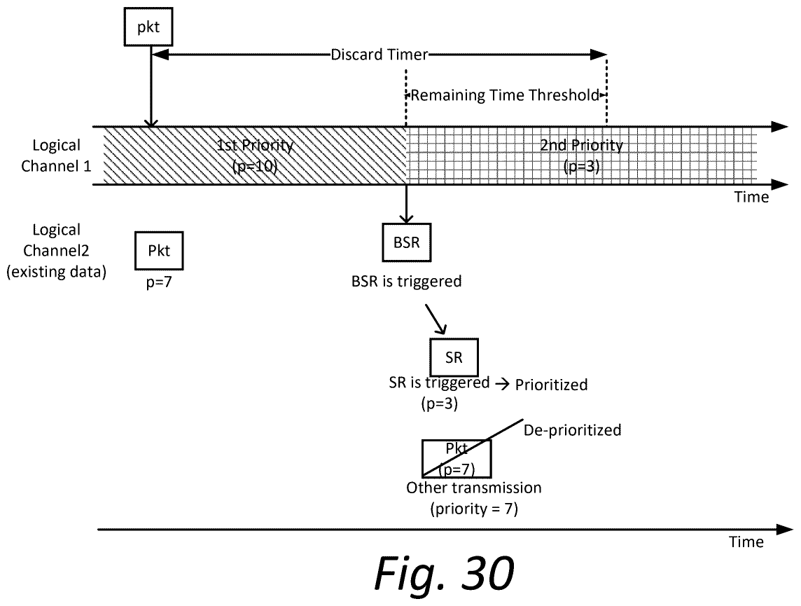

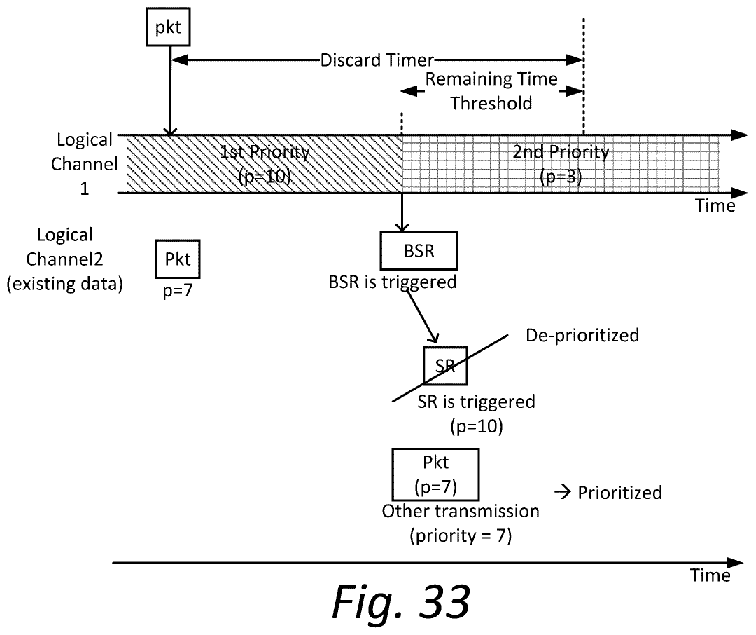

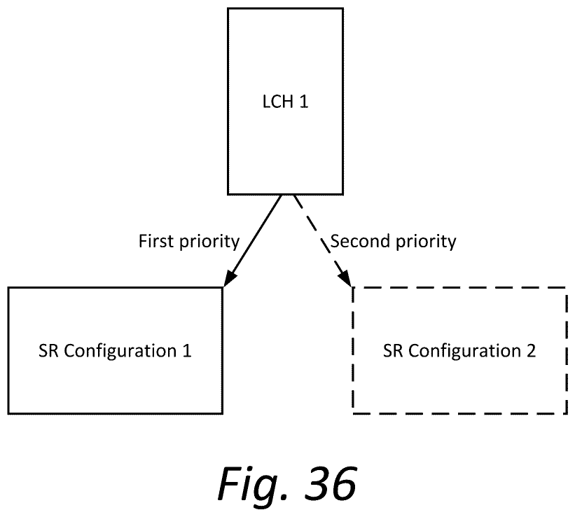

In prior art practice, the priority of an SR transmission is the same as the LCH priority which triggers the SR transmission. A third basic aspect of the technology disclosed herein concerns enhanced techniques for determining priority of a scheduling request, SR, transmission when dynamic priority is used. Three non-limiting, generic, example sub-aspects are described below and illustrated by FIG. 30, FIG. 33, and FIG. 36, respectively. In each of the sub-aspects, a node which serves as a receiver node, e.g., a base station, can configure two LCH priority values for each logical channel. The two priority values are configured by an RRC message transmitted by the receiver node to a node which serves as a scheduling request transmission node, e.g., wireless terminal UE. In the example of FIG. 30, the first priority value of LCH1 is 10 which is used when there is no available data with remaining time less than a threshold for this LCH. The second priority is 3 which is used when there is available data with remaining time less than a threshold for this LCH. It is assumed that LCH2 has only one priority value which is 7. At the beginning of the example of FIG. 30, it is assumed that only LCH2 with priority 7 has available data in the buffer. The highest LCH priority at this time is 7. Later, a packet for LCH1 arrives in the UE. When the packet arrives in the UE, the packet is not considered as urgent data. At the time of arrival of the packet, LCH1 does not have any urgent data, so the priority of LCH1 is 10. The example assumes the packet has not been transmitted until the remaining time is smaller than a remaining time threshold. Once there is a packet with remaining timer smaller than the threshold, the logical channel priority is changed to the second priority, i.e., priority 3, e.g., high priority. Then, LCH1 becomes the highest priority LCH which has available data and the priority of LCH1 is higher than any logical channel having available data. As described in scenarios such FIG. 18, FIG. 21, and FIG. 24, a BSR can be triggered to indicate the LCH priority change to the base station. Also, there can be other BSR triggering conditions. When a regular BSR has been triggered, a scheduling request, SR, can be triggered if one of the following conditions are satisfied [3GPP TS 38.321]:
There is no UL-SCH resource available for a new transmission.
The MAC entity is configured with configured uplink grant(s) and the Regular BSR was triggered for a logical channel for which a flag logicalChannelSR-Mask is set to false.
If the UL-SCH resources available for a new transmission do not meet the LCP mapping restrictions configured for the logical channel that triggered the BSR.

### 3.1 Priority of Scheduling Request Determined at Time of Triggering of Scheduling Request or Scheduling Request Transmission

According to sub-aspect 3.1, illustrated in FIG. 30, the priority of SR transmission is determined by the LCH priority which triggered the SR at the time of triggering the SR. In the example of FIG. 21 and FIG. 30, the SR is triggered by a regular BSR triggered by LCH1 and LCH priority at the time of triggering the SR is 3. Thus, the priority of the SR transmission is determined as 3. In the example of FIG. 30, the SR transmission overlaps with an uplink grant in time domain, which has data from an LCH with priority 7. Thus, the priority of the overlapped uplink grant is 7. Thus, the SR transmission is prioritized, and its transmission is indicated to the lower layer (i.e., physical layer), and the transmission is performed.

As a variation of sub-aspect 3.1, the priority of SR transmission is determined by the LCH priority which triggered the SR. When one of the SR triggering conditions is met, an SR is triggered. Later, when there is a PUCCH resource on which the triggered SR can be transmitted, the triggered SR is transmitted. After comparing the priority of the SR with priorities of other overlapping resources, the resource with highest priority is selected for transmission. FIG. 30 serves to also illustrate the case of the priority of SR transmission is determined by the LCH priority which triggered the SR.

When the priority of a logical channel which triggered an SR has been changed to lower priority, e.g., first priority, the triggered SR can be cancelled. The SR cancellation at priority change can be performed only if the SR was triggered due to the LCH priority change. When multiple SRs are pending, the SR triggered by the highest LCH can be prioritized for transmission.

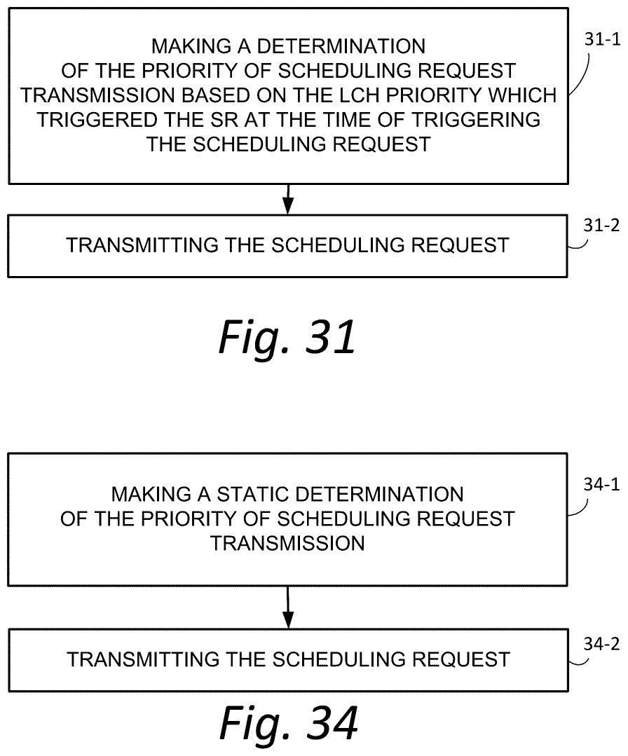

Example acts or steps comprising an example implementation of the scenario of FIG. 30 are shown in FIG. 31. Act 31-1 comprise the transmitter node making a determination of the priority of SR transmission based on the LCH priority which triggered the SR at the time of triggering the SR. Act 31-2 comprises the transmitter node transmitting the scheduling request to a receiver node in accordance with the determination of act 31-1.

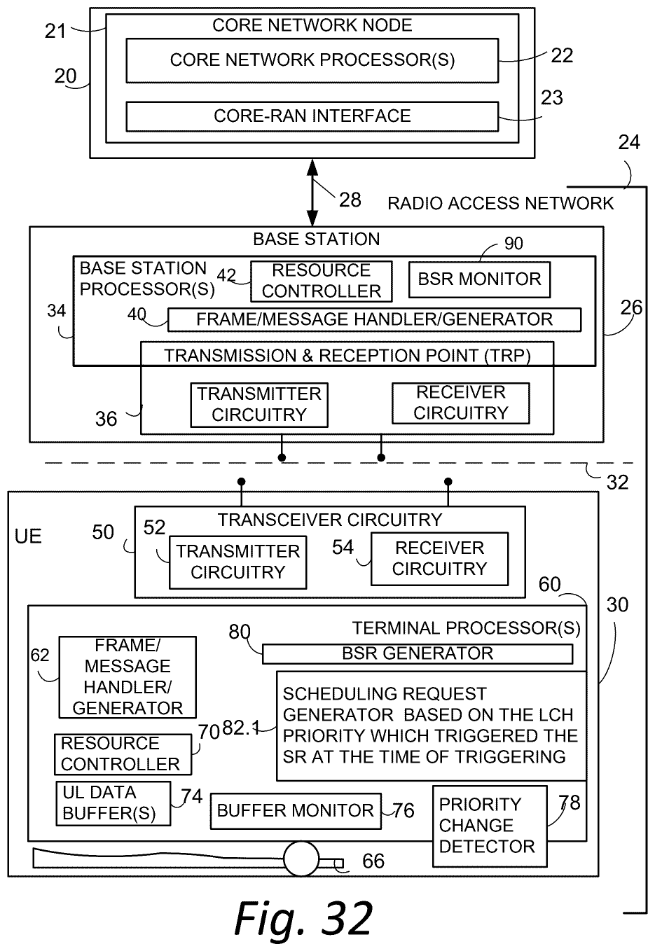

FIG. 32 shows an example communications system configured to implement the scenario of FIG. 30. In an example embodiment and mode, the structures and functionalities of FIG. 32 may be essentially the same as those described above, such as FIG. 26, for example. In the system of FIG. 32, the buffer status report generator 80 is shown generically and may be any of the buffer status report generators described herein. Moreover, the transmitter node, e.g., wireless terminal 30 of FIG. 32 further shows comprises scheduling request generator 82.1 which serves to generate the scheduling request with a priority based on the LCH priority which triggered the SR at the time of triggering the scheduling request as above described, e.g., with reference to FIG. 30 and FIG. 31.

### 3.2 Priority of Scheduling Request Statically Determined

According to sub-aspect 3.2, illustrated in FIG. 33, the node which serves as the transmitter node, e.g., the wireless terminal, UE, statically determines the priority of an SR transmission. In other words, the determination of the priority of the SR transmission is consistently one of the two priority values supplied by the receiver node, i.e., only the first priority value or the second priority value, regardless of the present LCH priority or LCH priority used in LCP for the MAC PDU or LCH priority at the time of triggering SR. In the example of FIG. 33, the determination is made using the first priority value, so that the priority of an SR transmission is determined as 10. In the example of FIG. 33, there is an overlapped uplink grant in time domain, which has data from an LCH with priority 7. Thus, the priority of the overlapped uplink grant is 7. So, the SR transmission with priority 10 is de-prioritized and its transmission is not performed by the lower layer, e.g., physical layer. The other overlapped grant with priority 7 is prioritized and delivered to the lower layer and transmitted to the receiver node. The method of sub-aspect 3-2 and FIG. 33 does not require to check the present LCH priority value, so implementation at the transmitter node can be simplified.

Although FIG. 33 shows static use of the first priority value for the SR, in another exemplary embodiment, the transmitter node may always use the second priority value considered regardless of the present LCH priority or LCH priority used in LCP for the MAC PDU or LCH priority at the time of triggering SR. Under this assumption, the priority of the SR is always 10 regardless of dynamic LCH priority. This can also reduce UE implementation complexity. In another exemplary embodiment, an LCH priority value used for determining the priority of a scheduling request, SR, can be configured by the base station to the UE via an RRC message. When multiple SRs are pending, the SR with the highest SR priority can be prioritized for transmission.

Example acts or steps comprising an example implementation of the scenario of FIG. 33 are shown in FIG. 34. Act 34-1 comprise the transmitter node making a static determination of the priority of SR transmission as understood with reference to FIG. 33. Act 34-2 comprises the transmitter node transmitting the scheduling request to a receiver node in accordance with the determination of act 34-1.

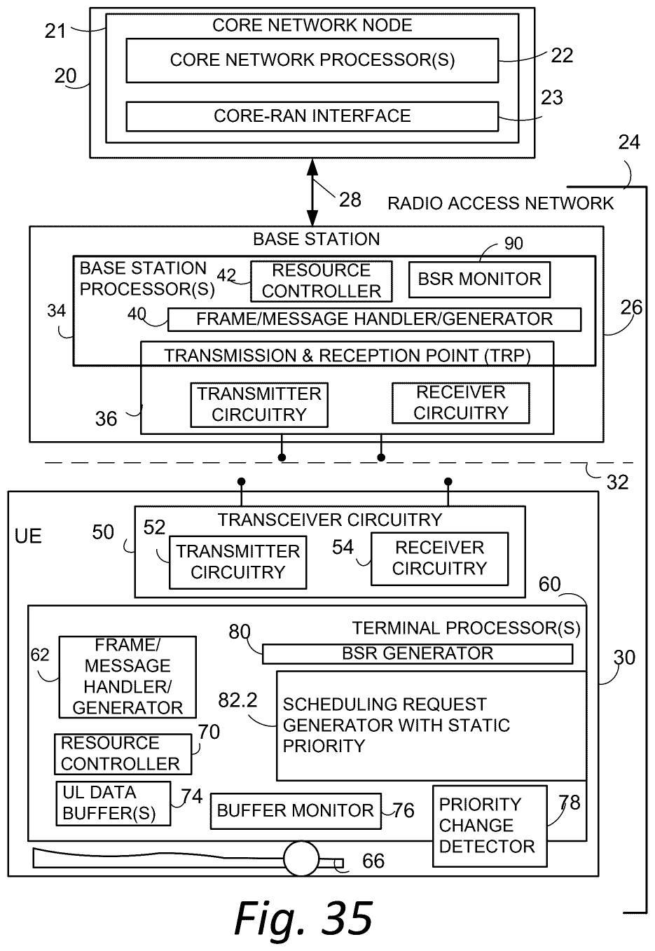

FIG. 35 shows an example communications system configured to implement the scenario of FIG. 33. In an example embodiment and mode, the structures and functionalities of FIG. 35 may be essentially the same as those described above, such as in FIG. 26, for example. In the system of FIG. 35, the buffer status report generator 80 is shown generically and may be any of the buffer status report generators described herein. Moreover, the transmitter node, e.g., wireless terminal 30 of FIG. 32 further shows comprises scheduling request generator 82.2 which serves to generate the scheduling request with a static priority as above described, e.g., with reference to FIG. 333 and FIG. 34.

### 3.3 Scheduling Request Configuration Selection

Traditionally, one logical channel has at most one scheduling request, SR, configuration. Section 3.2 involves dynamic LCH priority, in which the SR configuration used by the logical channel is changing, depending on LCH priority value at a given time. For example, a logical channel may be configured with more than one SR configuration.

FIG. 36 depicts a proposed method of SR configuration selection depending on LCH priority which triggers the SR. When dynamic LCH priority is used, two LCH priority values are configured for each logical channel. In accordance with sub-aspect 3.2 and FIG. 36, an SR configuration is associated with one LCH priority value. Depending on presence of urgent data, a LCH priority for each LCH can be determined. When this logical channel triggers an SR, the selected SR configuration depends on the LCH priority at the time of triggering the SR. When LCH1 triggers an SR and the LCH priority of LCH1 at the time of triggering the SR is the first priority, the first SR configuration is used. When LCH1 triggers an SR and the LCH priority of LCH1 at the time of triggering the SR is the second priority, the second SR configuration is used. In an exemplary embodiment, some of LCH priority value does not have any associated SR configuration. In this case, SR is not triggered. In the example, the second LCH priority may not have its associated SR configuration. However, it is possible that the first LCH priority may not have its associated SR configuration. Based on the received SR configuration, the base station can be aware of LCH priority of the logical channel.

Thus, in an example embodiment and mode the scheduling request, SR, priority is the same as LCH priority which trigger the SR. For example, when there is urgent data, LCH1's priority 3 selects SR configuration 1 for which the priority of is 3. When there is no urgent data, LCH1's priority 10 selects SR configuration 2, for which the priority is 10.

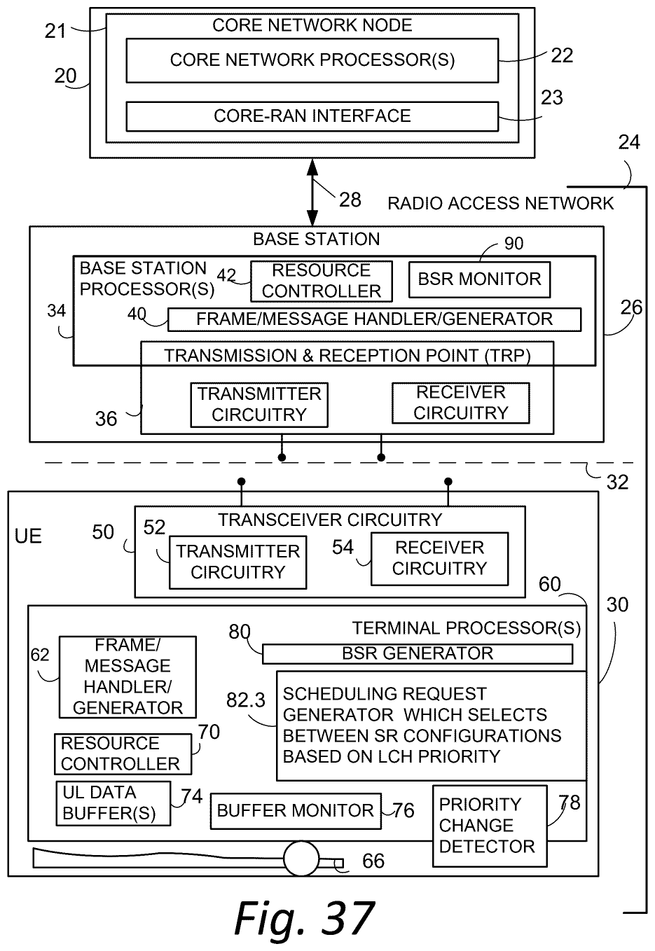

FIG. 37 shows an example communications system configured to implement the scenario of FIG. 36. In an example embodiment and mode, the structures and functionalities of FIG. 32 may be essentially the same as those described above, such as FIG. 30, for example. In the system of FIG. 37, the buffer status report generator 80 is shown generically and may be any of the buffer status report generators described herein. Moreover, the transmitter node, e.g., wireless terminal 30 of FIG. 32 further shows comprises scheduling request generator 82.3 which serves to generate the scheduling request by selecting between plural scheduling request configurations, the selection being based on the priority that the logical channel has at the time of the scheduling request generation described above with reference to FIG. 36.

### Further Considerations

It should be understood that the various foregoing example embodiments and modes may be utilized in conjunction with one or more example embodiments and modes described herein. For example, the example embodiments and modes of all aspects and sub-aspects of the technology disclosed herein may be utilized in combination with one or more other example embodiments and modes disclosed herein.

Certain units and functionalities of the communications systems may be implemented by electronic machinery. For example, electronic machinery may refer to the processor circuitry described herein, such as receiver node processors 34 and transmitter node processor(s) 60. Moreover, the term “processor circuitry” is not limited to mean one processor, but may include plural processors, with the plural processors operating at one or more sites. Moreover, as used herein the term “server” is not confined to one server unit but may encompass plural servers and/or other electronic equipment and may be co-located at one site or distributed to different sites. With these understandings, FIG. 38 shows an example of electronic machinery, e.g., processor circuitry, as comprising one or more processors 490, program instruction memory 492; other memory 494 (e.g., RAM, cache, etc.); input/output interfaces 496 and 497, peripheral interfaces 498; support circuits 499; and busses 500 for communication between the aforementioned units. The processor(s) 490 may comprise the processor circuitries described herein, for example, core node processor(s) 22, base station processors 34, and wireless terminal processor(s) 60.

A memory or register described herein may be depicted by memory 494, or any computer-readable medium, may be one or more of readily available memory such as random-access memory (RAM), read only memory (ROM), floppy disk, hard disk, flash memory or any other form of digital storage, local or remote, and is preferably of non-volatile nature, as and such may comprise memory. The support circuits 499 are coupled to the processors 490 for supporting the processor in a conventional manner. These circuits include cache, power supplies, clock circuits, input/output circuitry and subsystems, and the like.

The processes and methods of the disclosed embodiments may be implemented as a software routine. Alternatively or additionally, some or all of method steps that are disclosed therein may be performed in hardware as well as by a processor running software. As such, the embodiments may be implemented in software, as executed upon a computer system, in hardware as an application specific integrated circuit or other type of hardware implementation, or a combination of software and hardware. The software routines of the disclosed embodiments are capable of being executed on any computer operating system and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus, machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

The acts described herein, may be performed by a software program product stored tangibly on a non-transient computer-readable medium which, when executed by one or more processors as herein mentioned, performs such acts either in whole or in part.

Moreover, each functional block or various features of the receiver nodes and transmitter nodes employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves resource selection and resource utilization in a communications system.

The technology disclosed herein encompasses one or more of the following non-limiting, non-exclusive example embodiments and modes:
Example Embodiment 1: A node of a telecommunications system, the node comprising:
processor circuitry configured to make a determination of priority of a transmission grant dependent on a logical channel priority for a medium access control (MAC) protocol data unit (PDU) associated with the grant.
Example Embodiment 2: The node of Example Embodiment 1, wherein the logical channel priority for the protocol data unit depends on presence of urgent data in the protocol data unit.
Example Embodiment 3: The node of Example Embodiment 2, wherein urgent data comprises data for which remaining time until expiry of a discard timer is less than a predetermined threshold.
Example Embodiment 4: The node of Example Embodiment 1, wherein the node comprises a wireless terminal and the grant is an uplink grant received from a network node.
Example Embodiment 5: The node of Example Embodiment 1, wherein the processor circuitry is configured to make the determination based on a logical channel priority at a time of multiplexing of data for the protocol data unit.
Example Embodiment 6: The node of Example Embodiment 1, wherein the processor circuitry is configured to make a determination of priority of a transmission grant for retransmission of the protocol data unit dependent on the determination of priority of the transmission grant for an initial transmission of the protocol data unit.
Example Embodiment 7: The node of Example Embodiment 1, wherein the processor circuitry is configured to make a determination of priority of a transmission grant for retransmission of the protocol data unit dependent on a present logical channel priority.
Example Embodiment 8: The node of Example Embodiment 1, wherein the processor circuitry is configured to make the determination based on a static logical channel priority.
Example Embodiment 9: The node of Example Embodiment 8, wherein processor circuitry is configured to use a predetermined one of plural possible logical channel priorities to make the determination.
Example Embodiment 10: The node of Example Embodiment 1, wherein the processor circuitry is configured to make the determination dependent on data to be included in the protocol data unit for the transmission grant.
Example Embodiment 11: The node of Example Embodiment 10, wherein the processor circuitry is configured to make the determination dependent on whether the protocol data unit for the transmission grant includes data whose remaining time is smaller than a threshold.
Example Embodiment 12: The node of Example Embodiment 1, further comprising interface circuitry configured to transmit the protocol data unit across a radio interface to another node of the system in accordance with the priority of the grant.
Example Embodiment 13: A method in a node of a telecommunications system, the method comprising:
making a determination of priority of a transmission grant dependent on a logical channel priority for a medium access control (MAC) protocol data unit (PDU) associated with the grant;
transmitting the protocol data unit across a radio interface to another node of the system in accordance with the priority of a transmission grant.
Example Embodiment 14: A node of a telecommunications system, the node comprising:
processor circuitry configured to generate one or more message(s) comprising:
   plural possible logical channel priorities for a transmission grant to another node of the system which makes a selection between the plural possible logical channel priorities to be used by the another node in determining a priority of the transmission grant; and
   a threshold value to be used by the another node in determining a priority of the transmission grant;
interface circuitry configured to transmit the one or more messages across a radio interface to the another node and to receive at least one protocol data unit associated with the transmission grant.
Example Embodiment 15: The node of Example Embodiment 14, wherein the node comprises a node of a radio access network and the transmission grant is an uplink grant.
Example Embodiment 16: A node of a telecommunications system, the node comprising processor circuitry configured to generate a buffer status report upon occurrence of a logical channel priority change.
Example Embodiment 17: The node of Example Embodiment 16, further comprising interface circuitry configured to transmit the buffer status report across a radio interface to another node of the system.
Example Embodiment 18: The node of Example Embodiment 16, wherein the processor circuitry is configured to generate the buffer status report when a logical channel has available data for transmission.
Example Embodiment 19: The node of Example Embodiment 16, wherein the processor circuitry is configured to generate the buffer status regardless of presence of available data for a logical channel.
Example Embodiment 20: The node of Example Embodiment 16, wherein the processor circuitry is configured to generate the buffer status report when a priority of a logical channel becomes higher than any other logical channel having available data.
Example Embodiment 21: The node of Example Embodiment 16, wherein the processor circuitry is configured to generate the buffer status report when a LCH priority is changed to a higher priority.
Example Embodiment 22: The node of Example Embodiment 21, wherein the processor circuitry is configured to generate the buffer status report when a remaining time has become smaller than a threshold.
Example Embodiment 23: The node of Example Embodiment 16, wherein the processor circuitry is further configured to generate a subsequent buffer status report only after lapse of a predetermined time.
Example Embodiment 24: The node of Example Embodiment 16, wherein the node comprises a wireless terminal and the other node comprises a network node.
Example Embodiment 25: The node of Example Embodiment 16, wherein the buffer status report comprises an identifier of a logical channel group for which a logical channel priority change has occurred and an indication of the size of the buffer for the logical channel group.
Example Embodiment 26: The node of Example Embodiment 16, wherein the buffer status report comprises an identifier of a logical channel for which a logical channel priority change has occurred and a field indicative of whether the logical channel priority change has occurred.
Example Embodiment 287: The node of Example Embodiment 26, wherein the field indicative of whether the logical channel priority change has occurred indicates whether logical channel priority has increased or decreased.
Example Embodiment 28: The node of Example Embodiment 16, wherein the buffer status report comprises, for each of plural logical channels, an identifier of the logical channels and a field indicative of whether the logical channel priority change has occurred for the respective logical channel.
Example Embodiment 29: A method in a node of a telecommunications system, the method comprising:
generating a buffer status report upon occurrence of a logical channel priority change; and
transmitting the buffer status report across a radio interface to another node of the system.
Example Embodiment 30: A node of a telecommunications system, the node comprising:
interface circuitry configured to receive a buffer status report from another node of the system across a radio interface; and
processor circuitry configured to determine from the buffer status report whether the buffer status report was generated upon occurrence of a logical channel priority change.
Example Embodiment 31: A node of a telecommunications system which uses dynamic prioritization of logical channels, the node comprising:
processor circuitry configured to make a determination of priority of a scheduling request triggered by a logical channel.
Example Embodiment 32: The node of Example Embodiment 31, further comprising interface circuitry configured to transmit the scheduling request across a radio interface to another node of the system in accordance with the priority for the scheduling request.
Example Embodiment 33: The node of Example Embodiment 31, wherein the processor circuitry is configured to make the determination based on a logical channel priority at a time of triggering of the scheduling request transmission.
Example Embodiment 34: The node of Example Embodiment 31, wherein the processor circuitry is configured to make the determination based on a logical channel priority at a time of transmission of the scheduling request.
Example Embodiment 35: The node of Example Embodiment 31, wherein the processor circuitry is configured to make the determination based on a logical channel priority at a time of multiplexing of data for the protocol data unit.
Example Embodiment 36: The node of Example Embodiment 31, wherein the processor circuitry is configured to make the determination based on a static logical channel priority.
Example Embodiment 37: The node of Example Embodiment 36, wherein the processor circuitry is configured to a predetermined one of plural priorities to make the determination.
Example Embodiment 38: The node of Example Embodiment 37, wherein the node is configured by signaling from another node to use the predetermined one of plural priorities to make the determination.
Example Embodiment 39: The node of Example Embodiment 31,, wherein the processor circuitry is further configured to cancel the scheduling request when the priority of the logical channel which triggered the scheduling request has been changed to a lower priority.
Example Embodiment 40: The node of Example Embodiment 31, wherein the processor circuitry to configured to make a determination of priority of a scheduling request for a dynamically prioritized logical channel by selecting between plural scheduling request configurations, the plural scheduling request configurations corresponding to respective plural priorities associated with the dynamically prioritized logical channel.
Example Embodiment 41: A method of operating a node of a telecommunications system which uses dynamic prioritization of logical channels, the method comprising:
making a determination of priority of a scheduling request triggered by a logical channel; and
transmitting the scheduling request across a radio interface to another node of the system in accordance with the priority for the scheduling request.
Example Embodiment 42: A node of a telecommunications system which uses dynamic prioritization of logical channels, the node comprising:
processor circuitry configured to select between plural scheduling request configurations depending on a LCH priority which triggers the scheduling request.
Example Embodiment 43: The node of Example Embodiment 42, wherein the processor circuitry is configured to select between the plural scheduling request configurations at a time of triggering the scheduling request.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A node of a telecommunications system, the node comprising processor circuitry configured to generate a buffer status report upon occurrence of a logical channel priority change.

2. The node of claim 1, further comprising interface circuitry configured to transmit the buffer status report across a radio interface to another node of the system.

3. The node of claim 1, wherein the processor circuitry is configured to generate the buffer status report when a logical channel has available data for transmission.

4. The node of claim 1, wherein the processor circuitry is configured to generate the buffer status regardless of presence of available data for a logical channel.

5. The node of claim 1, wherein the processor circuitry is configured to generate the buffer status report when a priority of a logical channel becomes higher than any other logical channel having available data.

6. The node of claim 1, wherein the processor circuitry is configured to generate the buffer status report when a LCH priority is changed to a higher priority.

7. The node of claim 6, wherein the processor circuitry is configured to generate the buffer status report when a remaining time has become smaller than a threshold.

8. The node of claim 1, wherein the processor circuitry is further configured to generate a subsequent buffer status report only after lapse of a predetermined time.

9. The node of claim 1, wherein the node comprises a wireless terminal and the other node comprises a network node.

10. The node of claim 1, wherein the buffer status report comprises an identifier of a logical channel group for which a logical channel priority change has occurred and an indication of the size of the buffer for the logical channel group.

11. The node of claim 1, wherein the buffer status report comprises an identifier of a logical channel for which a logical channel priority change has occurred and a field indicative of whether the logical channel priority change has occurred.

12. The node of claim 11, wherein the field indicative of whether the logical channel priority change has occurred indicates whether logical channel priority has increased or decreased.

13. The node of claim 1, wherein the buffer status report comprises, for each of plural logical channels, an identifier of the logical channels and a field indicative of whether the logical channel priority change has occurred for the respective logical channel.

14. A method in a node of a telecommunications system, the method comprising:
generating a buffer status report upon occurrence of a logical channel priority change; and
transmitting the buffer status report across a radio interface to another node of the system.

15. A node of a telecommunications system, the node comprising:
interface circuitry configured to receive a buffer status report from another node of the system across a radio interface; and
processor circuitry configured to determine from the buffer status report whether the buffer status report was generated upon occurrence of a logical channel priority change.
